(19) United States
(12) Patent Application Publication
(10) Pub. No.: US 2026/0342955 A1
(43) Pub. Date: Oct. 29, 2026

(54) CURRENT MODULATION BASED ON AMBIENT LIGHT FOR A TRANSPARENT DISPLAY

(71) Applicant: GOOGLE LLC, Mountain View, CA (US)

(72) Inventors: Hagar Adler, Seattle, WA (US); Björn Nicolaas Servatius Vlaskamp, Seattle, WA (US); Pierre St. Hilaire, Belmont, CA (US); Alexandra Elizabeth Boehm, San Jose, CA (US)

(21) Appl. No.: 19/653,444

(22) Filed: Apr. 21, 2026

Related U.S. Application Data
(60) Provisional application No. 63/794,146, filed on Apr. 24, 2025.

(51) Int. Cl. H04N 13/327; H04N 13/324; H04N 13/398

(52) U.S. Cl. CPC H04N 13/327; H04N 13/324; H04N 13/398

(57) ABSTRACT

A display system detects an ambient level of light in an environment in which a transparent display with an array of emitters is operated. Based on the ambient level, the display system determines a profile from a plurality of profiles associated with the transparent display, the profile being associated with a current for a primary color defining a color space displayable by the transparent display. The display system drives the array of emitters at the current, based on the profile and using drive signals defined by a relationship that is modified to maintain a white point for the color space. Corresponding methods and devices are also disclosed.

### CROSS REFERENCE TO RELATED APPLICATION

This application claims the benefit of U.S. Provisional Application No. 63/794,146, filed Apr. 24, 2025, the disclosure of which is incorporated herein by reference in its entirety.

### BACKGROUND

Transparent displays, such as optical see-through (OST) displays used in head-mounted extended reality (XR) devices, may present virtual content while allowing a user to continue viewing a real-world environment through the display optics. In such systems, light generated by the display is added to ambient light from the environment rather than replacing the environmental view. As a result, visibility of the virtual content may vary to a substantial degree with ambient conditions. For example, in bright outdoor environments, ambient light may raise a luminance floor that reduces contrast and makes virtual objects more difficult to perceive, while in dimmer environments the same display may be capable of presenting richer and more saturated colors.

A significant challenge in the design of such systems involves ensuring that the virtual content remains clearly visible and discriminable across a wide range of lighting conditions. In high-ambient environments, such as bright sunlight outdoors, the background light can wash out the display content, making virtual objects appear transparent or otherwise difficult to resolve. Conventional approaches to maintaining visibility often involve increasing the global brightness of the display, which can lead to significant power consumption, reduced battery life, and thermal management challenges in compact wearable devices.

### SUMMARY

Transparent displays, such as optical see-through (OST) displays, may operate in environments having substantially different ambient light levels. In these systems, ambient light from the environment is additive to display light, which can make content harder to see and can make different operating conditions favor different display behaviors. For example, a transparent display may be more effective in one ambient condition when operated with one analog current regime and may be more effective in another ambient condition when operated with a different analog current regime. Principles described herein address these and other technical issues by using the ambient light level to select a profile for the transparent display, where the profile is associated with a current (e.g., an analog current) for a native color component (e.g., a primary color) defining a color space displayable by the transparent display (e.g., a native gamut that the display can provide using that profile). Based on the selected profile, the system may also modify a relationship (e.g., a mapping) between digital values representative of content and drive signals for driving an array of emitters of the transparent display at the current, such that the relationship is modified to maintain a white point for the set of colors. The array of emitters is then driven at the current using the drive signals defined by the relationship as modified. As a result, the transparent display may provide improved visibility and more consistent color behavior across different ambient conditions, even though different ambient conditions and operating regimes may still support different available color performance.

In some aspects, the techniques described herein relate to a method including: detecting an ambient level of light in an environment in which a transparent display with an array of emitters is operated; determining, based on the ambient level, a profile from a plurality of profiles associated with the transparent display, the profile being associated with a current for a primary color defining a color space displayable by the transparent display; and driving, based on the profile and using drive signals defined by a relationship that is modified to maintain a white point for the color space, the array of emitters at the current.

In some aspects, the techniques described herein relate to a display system including: a transparent display having an array of emitters; a sensor configured to detect an ambient level of light in an environment in which the transparent display is operated; and a controller communicatively coupled to the transparent display and the sensor, the controller configured to: determine, based on the ambient level, a profile from a plurality of profiles associated with the transparent display, the profile being associated with a current for a primary color defining a color space displayable by the transparent display; and drive, based on the profile and using drive signals defined by a relationship that is modified to maintain a white point for the color space, the array of emitters at the current.

In some aspects, the techniques described herein relate to a non-transitory computer-readable medium storing instructions that, when executed by a controller of a display system having a transparent display with an array of emitters, cause the display system to perform a method including: detecting an ambient level of light in an environment in which the transparent display is operated; determining, based on the ambient level, a profile from a plurality of profiles associated with the transparent display, the profile being associated with a current for a primary color defining a color space displayable by the transparent display; and driving, based on the profile and using drive signals defined by a relationship that is modified to maintain a white point for the color space, the array of emitters at the current.

Various implementations, such as methods, systems, and computer-readable media, are disclosed herein. The reader will understand that these various implementations are not mutually limiting with one another. For example, operations described in the context of a method may be performed by a suitably configured system, and a system may be configured to perform operations described as part of a method. Similarly, instructions stored on a computer-readable medium may cause a system to perform a disclosed method. Further details of these and other implementations are set forth in the accompanying drawings and the description below.

### BRIEF DESCRIPTION OF THE DRAWINGS

FIG. 1 shows an illustrative comparison of a transparent display operated in different ambient-light scenarios to present content using different color spaces in accordance with principles described herein.

FIG. 2 shows a block diagram of an illustrative transparent display configured to perform current modulation based on ambient light in accordance with principles described herein.

FIG. 3 shows a flowchart of an illustrative method for performing current modulation based on ambient light for a transparent display in accordance with principles described herein.

FIG. 4A shows an illustrative comparison of different color spaces associated with a fixed operating regime of a transparent display in different ambient light scenarios in accordance with principles described herein.

FIG. 4B shows an illustrative comparison of different color spaces associated with different profiles of a transparent display in different ambient light scenarios in accordance with principles described herein.

FIG. 4C shows an illustrative overlay of color spaces associated with different profiles of a transparent display in accordance with principles described herein.

FIG. 5 shows a flowchart of an illustrative process for driving an emitter to an appropriate brightness given a particular ambient lighting scenario in accordance with principles described herein.

FIG. 6A shows an illustrative set of profiles for a transparent display in which analog current is varied for a first primary color defining a color space in accordance with principles described herein.

FIG. 6B shows an illustrative set of profiles for a transparent display in which analog current is varied for each of the primary colors defining a set of colors in accordance with principles described herein.

FIG. 6C shows an illustrative set of profiles for a transparent display in which analog current is varied for a first primary color and a second primary color defining a color space while a third primary color remains fixed in accordance with principles described herein.

FIG. 7 shows a block diagram of an illustrative pixel driver configured to provide different analog currents based on a selected profile in accordance with principles described herein.

FIG. 8 shows illustrative profile-selection schemes for mapping ambient levels to profiles of a transparent display in accordance with principles described herein.

FIG. 9 shows a block diagram of an illustrative computing system in accordance with principles described herein.

### DETAILED DESCRIPTION

A transparent display such as an optical see-through (OST) display may face a practical challenge: the display is expected to look colorful and clear in different environments, even though the real world remains visible through the display and ambient light is added to the display light. In a darker environment, the transparent display may have enough contrast to present a relatively broad and saturated color space (e.g., supported gamut or set of colors) efficiently. In a brighter environment, however, the ambient light may raise the luminance floor and wash out portions of that color space, such that some colors become difficult to perceive or may not be perceptible unless the display is operated differently. This challenge may be further complicated in implementations that use micro light-emitting diode (microLED) emitters because changing the analog current used to drive one or more native primary colors (e.g., red, green, or blue) may also change the native color behavior of the transparent display. Accordingly, rather than forcing the transparent display to operate with a single fixed analog current regime in all environments, technical solutions described herein involve detecting and using ambient conditions to select among different profiles for the transparent display, where different profiles are associated with different current regimes and different relationships between digital values and drive signals. In this way, the transparent display may operate in a manner better suited for the environment at hand, preserving access to richer colors when conditions allow, supporting improved visibility when ambient light is high, and maintaining a desired white point across different operating regimes even when certain saturated colors may be unavailable.

The technological context of implementations described herein, as well as various technical problems they address, technical solutions they propose, and technical benefits they provide, will now be described in more detail.

Principles described herein relate generally to transparent displays, such as optical see-through (OST) displays, that present virtual content while a user continues to see a real-world environment through the display. In these systems, display light is not presented in isolation. Instead, the display light is added to ambient light from the environment. This creates a technological setting that differs in an important way from conventional opaque displays such as televisions, monitors, and phones. In a conventional opaque display, the system has much greater control over the visual field because the displayed image can effectively define both bright portions and dark portions of the image. In a transparent display, by contrast, the environment remains visible, and the ambient light of that environment may function as a luminance floor against which the virtual content must compete. As a result, the same transparent display may behave very differently in a dim indoor setting than in a bright outdoor setting, even when the same content is being presented.

This additive nature of light in transparent displays gives rise to a set of technical problems associated with visibility, color presentation, and operating efficiency. When ambient light is relatively low, a transparent display may be capable of presenting a richer and more saturated color space because the virtual content does not have to compete as aggressively with the environment. When ambient light is relatively high, however, the display may need to produce significantly more luminance for the content to remain perceptible. In that higher-ambient scenario, colors near the edges of the color space (e.g., a native color gamut defined by the primary colors) may become difficult to perceive even if they are theoretically part of the display's supported color space. This is because the ambient light effectively washes out portions of the virtual image. Accordingly, a transparent display is not merely tasked with reproducing color accurately in the abstract. Rather, it is tasked with doing so under environmental conditions that may substantially change what colors are practically visible and what display operating regimes are useful.

These technical problems may be further complicated in transparent displays that utilize micro light emitting diode (microLED) emitters or other emitters whose optical behavior varies with analog current. In certain examples, a native primary of the transparent display may shift in chromaticity as the corresponding emitters are driven at different analog currents. For example, a red primary color associated with AlInGaP-based emitters may shift toward shorter wavelengths as the analog current increases. This means that increasing analog current may do more than increase brightness. It may also change the native color space or set of colors that is displayable by the transparent display. Consequently, a drive regime that is useful for achieving visibility in a bright environment may be associated with a different native gamut than a drive regime that is useful in a dim environment. This creates a practical tension between brightness capability and color capability that is especially relevant in transparent displays, where ambient light conditions may vary widely during ordinary use.

Conventional approaches have generally not addressed this tension in a satisfactory way. In some display systems, the analog current regime is effectively fixed, and the system relies on digital modulation to move brightness up and down within that fixed hardware state. For a transparent display, this can produce undesirable compromises. If the fixed analog current regime is selected to support bright outdoor operation, the display may remain in a higher-current state even in dimmer conditions, which may lead to a smaller and less vibrant native color space than would otherwise be available, as well as unnecessary power usage. If, on the other hand, the fixed analog current regime is selected to favor lower-current operation and richer color in dim conditions, the display may have insufficient brightness capability for high-ambient scenarios. In some scenarios, the limitation may be so severe that even colors near a white point may fail to satisfy a desired contrast ratio relative to the ambient environment. Thus, a single fixed analog current regime may be poorly suited to the full operating range expected of a transparent display.

Other conventional responses likewise tend to fall short because they act within a fixed hardware color state rather than adapting the hardware color state itself. For example, a system may modify digital brightness, apply software color adjustments, or map content into a standard color space such as sRGB while leaving the native primaries of the transparent display unchanged. While such measures may help in certain respects, they do not alter the physical native set of colors that the hardware can produce under a given analog current regime. As a result, these approaches may still confine the system to a single hardware gamut even though different ambient conditions may favor different native gamuts. In a transparent display, where visibility and color capability are both tied to the relationship between ambient light and display light, that limitation can be particularly consequential.

To better address the technical problems described above, technical solutions are provided herein that involve a transparent display operating according to different profiles associated with different ambient conditions. Rather than treating the display as having one fixed native operating state, the system may detect an ambient level in an environment in which the transparent display is operated and, based on the ambient level, select a profile from a plurality of profiles associated with the transparent display. A selected profile may define an analog current for at least one native primary color such as red, blue, or green (and, in some implementations, multiple or all of the primary colors) of the color space displayable by the transparent display. In this way, the system may change not merely how strongly the display is driven in a digital sense, but also the underlying analog current regime that helps define the display's native color behavior. The result is a display architecture that may adapt its hardware operating state to the ambient environment rather than forcing one hardware state to serve every scenario.

In a relatively dim environment, the selected profile may correspond to a lower analog current regime that supports a larger or more saturated native color space, but that lower analog current regime may also provide reduced luminance capability relative to a higher analog current regime. In a relatively bright environment, in contrast, the selected profile may correspond to a higher analog current regime that supports increased luminance capability, even if the native set of colors is shifted or reduced in certain respects. Thus, the tradeoff may operate in both directions: the lower analog current regime may be desirable in dim ambient-light conditions because it can preserve a larger gamut and greater saturation when the reduced luminance capability remains sufficient for visibility, whereas the higher analog current regime may be desirable in bright ambient-light conditions because increased luminance capability may outweigh a reduction in saturation or gamut extent. Stated differently, the lower analog current regime may not be suitable across all scenarios because the associated reduction in luminance capability may become limiting in brighter environments. By allowing the transparent display to operate with different native color states in different ambient conditions, the system may preserve richer color capability when conditions allow and may provide improved visibility when ambient light is high.

In certain implementations, this adaptation may be carried out in a synchronized manner. For example, a sensor (e.g., an ambient light sensor, image sensor, photosensor array, or another suitable sensor) may provide ambient levels to a controller. The controller may then select a profile and modify a relationship (e.g., a mapping) between digital values representative of content and drive signals for driving the emitters of the transparent display at the analog current associated with the selected profile. Because the primary colors native to the color space may shift as the analog current changes, the relationship may also be modified to maintain a white point for the set of colors. For example, if a red native primary shifts when a higher-current profile is selected, the system may modify relative drive relationships among red, green, and blue channels so that a desired white point, such as D65, remains substantially intact. In this manner, the system may accommodate changes in native gamut while still preserving consistent behavior for shared colors and neutral colors that are intended to remain stable across different operating regimes.

The use of profiles may also support technical solutions that are practical from a product perspective. In certain examples, the plurality of profiles may include a discrete set of profiles, such as a lower-brightness profile and a higher-brightness profile, with ambient levels being mapped into corresponding operating bands. This approach may reduce calibration complexity as compared to a design that attempts to characterize and maintain a large number of distinct analog current regimes. For instance, in some implementations, a relatively small number of profiles may be sufficient where resulting analog states remain perceptually distinguishable from one another. For example, a practical minimum number of profiles may be selected such that a perceptual color difference between resulting primary colors associated with adjacent analog-current settings satisfies a threshold, such as ΔE₀₀>3, though other thresholds may be used in other implementations. At the same time, the system is not limited to two profiles, and additional profiles may be used where appropriate, such as to provide finer control across different ambient-light conditions even where calibration complexity increases. Likewise, the analog current changes may be applied to one primary color, such as red, or to multiple primary colors (e.g., red, green, and/or blue), depending on the optical behavior of the associated emitters. In certain examples, one native primary color may be the principal contributor to the chromaticity shift and may therefore be the primary channel that is modulated, while another primary color may remain fixed or may be modulated differently.

In accordance with certain technical solutions, the selected profile may work in conjunction with a target contrast (e.g., a desired contrast ratio associated with suitable visibility in the current environment). For example, after the system selects a profile associated with an analog current regime, the system may determine a global brightness or other operating parameter appropriate for that regime and the current ambient condition. This sequence may be beneficial because the selected analog current regime may define the available brightness headroom and the native color space with which the transparent display is operating. Once that regime is established, the system may determine how to present content using the corresponding mapping and brightness behavior. As a result, the transparent display may respond to ambient conditions through a coordinated update of its analog current regime, its color mapping (i.e., the relationship between digital content values and drive signals to be provided to the emitters), and its presentation behavior, rather than through isolated adjustments that fail to account for the physical state of the display hardware.

These technical solutions and other solutions described herein may provide a number of beneficial technical effects. For example, the transparent display may provide improved visibility across a range of ambient conditions while avoiding the inefficiencies of remaining in a higher-current regime when such a regime is not useful. The transparent display may also provide more consistent color behavior for shared colors and white-point-sensitive content (e.g., specific shades such as may be required for product logos or user interfaces) even as native primary colors shift with analog current. In addition, the system may make productive use of the fact that different ambient conditions support different practical color capabilities, rather than forcing the display to behave as though a single fixed color space is equally appropriate in each case. In this respect, the disclosed approach may provide a more power-efficient and perceptually appropriate balance between color saturation, brightness capability, and environmental visibility for transparent displays.

The practical significance and clear observability of technical solutions described herein may serve as another beneficial technical effect. Because the selected profile may correspond to a materially different native color state, a change in ambient conditions may produce a perceptible difference in how certain saturated colors are presented. For example, when a sensor reading causes the system to transition between profiles, a saturated red asset may shift between a deeper red state and a more orange-red state depending on the associated analog current regime. This perceptible difference may be a consequence of the same technical mechanism that allows the system to better match the transparent display to the ambient environment. Accordingly, it will be understood that principles described herein are directed not to a merely abstract software preference, but to a coordinated control of hardware operating state and color mapping that changes how the transparent display physically presents content in response to ambient conditions.

Certain terminology used in this description may be understood in the following sense to aid in describing principles set forth herein. These definitions are provided as examples and are not intended to be limiting; they may be added to, modified, and/or further clarified by the examples described herein. In addition, unless the context requires otherwise, terms described in the singular may also encompass the plural, and terms described in the plural may also encompass the singular.

As used herein, a “display system” may refer to an electronic apparatus configured to present visual information to a user. In some examples, the display system may be an “extended reality display system,” which may refer to a system configured to support augmented reality, mixed reality, virtual reality, and/or another extended reality experience. A “head-mounted display” may refer to a wearable display system positioned on or near a user's head, such as glasses, goggles, a visor, or another head-supported device. A “transparent display” may refer to a display through which a user may view at least part of an external scene while display light is emitted for presentation of content. In some examples, the transparent display may be an optical see-through (OST) display configured to combine emitted display light with ambient light from an “environment,” which may refer to a physical space, scene, object set, surface set, or other portion of the real world visible through the transparent display. A component described as being “integrated with” another component may be formed together with, mounted on, packaged with, communicatively coupled to, positioned within, or otherwise incorporated into the other component or system in any suitable manner.

As used herein, an “ambient level of light” may refer to any measure, estimate, characterization, or representation of light associated with an environment in which a transparent display is operated. In some examples, the ambient level of light may correspond to a luminance, illuminance, brightness, intensity, spectral characteristic, color characteristic, or another optical property of the environment, and may be represented by a single value, a set of values, a range, a regional distribution, or another suitable representation. Thus, determining or detecting an ambient level of light may include detecting one overall level for an environment, detecting respective levels for different regions, detecting a change over time, and/or inferring a level from sensor data. A “sensor” may refer to any component configured to detect or provide information indicative of ambient conditions, display conditions, user conditions, and/or another operating condition. Examples of a sensor may include an “ambient light sensor,” an “image sensor,” and an “array of photosensors.” An ambient light sensor may refer to a sensor configured to detect ambient light incident on or near the display system. An image sensor may refer to a sensor configured to capture image information representative of at least part of an environment. An array of photosensors may refer to a plurality of photosensitive elements distributed spatially so as to provide multiple measurements across a field of view, display area, and/or environment.

As used herein, a “profile” may refer to any operating mode, operating state, operating configuration, parameter set, data structure, lookup entry, or logical grouping of settings associated with operation of a transparent display. In some examples, a profile may define, identify, and/or be associated with a current for one or more primary colors, a color space, a relationship between values representative of content and drive signals, a global brightness behavior, a target contrast, a white point treatment, and/or another display characteristic. A “criterion” may refer to any benchmark, rule, condition, threshold, range, target, or decision basis used in selecting, maintaining, updating, or transitioning between profiles or other display behaviors. In some examples, the criterion may include a visibility criterion, a brightness criterion, a contrast criterion, a color criterion, a power criterion, a temporal criterion, and/or another criterion. A “discrete set” may refer to a set having separate members, such as two or more individually selectable profiles or modes, whether evenly spaced or unevenly spaced. A “low-brightness mode” and a “high-brightness mode” may refer to different operating modes associated with different brightness capabilities, different current levels, different color spaces, different power usage levels, and/or other different operating characteristics, and need not imply only two possible modes unless expressly stated. A “transition” may refer to any change, switch, update, interpolation, ramp, handoff, blending operation, or movement from one state, mode, profile, or condition to another.

As used herein, “current” may refer to an electrical (e.g., analog) drive current used in connection with operating one or more emitters, channels, pixels, subpixels, or other display elements. “Analog current,” in particular, may refer to a current magnitude or current level that is established independently of pulse-width modulation and that helps define a color space or other operating regime of a display element or color channel. In some implementations, analog current may be adjustable among multiple levels, may be selected from a set of predefined values, and/or may be produced by one or more current sources. A “fixed current” may refer to a current that is held constant across different scenarios while “modulated current” may refer to a current that is varied, selected, updated, stepped, ramped, switched, or otherwise controlled across different scenarios or conditions.

As used herein, an “emitter” may refer to any light-producing element, such as a micro light-emitting diode (microLED), other light-emitting diode (LED), laser element, or another emissive device. An “array of emitters” may refer to any plurality or arrangement of emitters, including a two-dimensional array with a plurality of rows or columns. “Driving” an emitter at a current may refer to operating, energizing, biasing, controlling, and/or causing one or more emitters to emit light using the current, whether alone or in combination with one or more additional drive controls such as pulse-width modulation, voltage control, timing control, digital codes, and/or enable signals. A “pixel driver” may refer to circuitry configured to drive one or more emitters associated with a pixel, subpixel, region, color channel, or other portion of a display. A “current source” may refer to any circuit element, driver branch, transistor arrangement, programmable source, or other structure capable of sourcing or controlling current. Such a current source may be “enabled” when activated, selected, turned on, connected, made available, and/or otherwise placed in a state that allows the current source to contribute to the driving of one or more emitters. A “combination of enabled current sources” may refer to any one or more current sources that are concurrently active so as to collectively establish or contribute to a current level.

As used herein, a “primary color” may refer to a color basis, color channel, emitter-defined color, native channel color, or other constituent color used to define or generate a color space for a display. In some examples, a primary color may correspond to red, green, blue, or another channel color. A “native” primary color may refer to a primary color associated with the optical behavior of a display, emitter technology, or hardware operating state under a given operating condition (e.g., when operating in a certain mode or profile). A “color space” displayable by a display may refer to any set, range, gamut, volume, locus, region, or collection of colors that the display is capable of presenting under a given operating condition (e.g., given a set of native primary colors). Thus, a color space may vary with current, profile, emitter behavior, calibration, drive conditions, and/or other factors. A “white point” for a color space may refer to a target, reference, intended, measured, or perceived achromatic point associated with a display or color space, such as a point corresponding to a desired neutral appearance. For example, a “D65” white point may refer to a standard or reference white point associated with daylight-like illumination, such as a white point having chromaticity coordinates corresponding to the CIE Standard Illuminant D65. References herein to maintaining or targeting D65 may include maintaining or targeting that white point exactly or approximately, including within a tolerance, threshold, or calibration range suitable for a given implementation. To “maintain a white point” may refer to preserving, holding, approximating, matching, compensating for, recalibrating toward, or otherwise causing a white point to remain the same or sufficiently similar notwithstanding other changes in operating conditions.

As used herein, a “reference” item, such as a reference profile, reference primary color, reference color space, or reference white point, may refer to a baseline, comparison, nominal, prior, selected, default, or otherwise designated item used for comparison, calibration, compensation, or evaluation. A “color shift” may refer to any change in color, chromaticity, hue, saturation, wavelength characteristic, or perceived color behavior. A “ratio of drive signals” may refer to any relative proportion, comparison, weighting, scaling, or relationship among drive signals associated with different channels, emitters, or primary colors. An “overlapping region” may refer to a portion shared by two or more color spaces, gamuts, or regions. Colors in an overlapping region may “appear equivalent” when they are the same, substantially the same, visually matched, perceptually similar, within a threshold similarity, and/or otherwise sufficiently alike for a given application. A “perceptual color difference” may refer to any measure, estimate, or representation of a perceived difference between colors. “ΔE₀₀” may refer to a color-difference metric according to the CIEDE2000 framework or another implementation derived therefrom.

As used herein, “content” may refer to visual information intended to be presented by a display, including text, graphics, user interface elements, symbols, icons, images, video, virtual objects, and/or any other displayed information. “Values” or “digital values” representative of content may then refer to any numerical representations, codes, data, signals, metadata, coordinates, or other information indicative of content to be presented. In some examples, values representative of content may include digital pixel values, grayscale values, RGB values, code values, intensity values, luminance-related values, and/or color-coordinate values. A “relationship” may refer to any mapping, correspondence, function, transform, table, lookup rule, proportionality, algorithmic association, or other association between one thing and another. Thus, a relationship between values representative of content and drive signals may be implemented mathematically, logically, algorithmically, by a lookup table, by circuitry, or in any other suitable manner. “Drive signals” may refer to any electrical, digital, analog, timing, enable, modulation, current-setting, voltage-setting, pulse, duty-cycle, and/or control signals used in driving emitters. “Pulse-width modulation” may refer to modulation based on variation of pulse width, duty cycle, on-time proportion, and/or another temporal characteristic of a drive waveform. A “global brightness” may refer to an overall brightness setting, brightness parameter, brightness level, or brightness control applied across a display, across a region of a display, and/or across a set of content, whether uniformly or according to a common control framework.

As used herein, a “target contrast” or “contrast ratio” may refer to any desired, selected, threshold, minimum, target, or otherwise relevant contrast relationship between displayed content and an environment, background, ambient level, aggregate light level, or other comparison basis. Such a contrast ratio may be expressed as a quotient, factor, percentage, differential relationship, or another measure of distinguishability. In some examples, a target contrast may be used in determining a profile, selecting a current, establishing a global brightness, modifying a relationship between values representative of content and drive signals, and/or evaluating whether content is likely to be sufficiently visible. A “controller” may refer to any processor, control circuit, logic device, state machine, microcontroller, driver circuit, graphics processor, application processor, or other circuitry configured to control one or more operations described herein, alone or in combination with memory and/or software. A controller may be integrated with a display system, a head-mounted display, a pixel driver, a sensor system, and/or another component, or may be separate therefrom. “Micro light-emitting diodes” or “microLEDs” may refer to light-emitting diodes having microscale dimensions suitable for use in high-density emissive displays, though no particular size threshold is required unless expressly stated.

Various implementations will now be described in more detail with reference to the figures. It will be understood that particular implementations described below are provided as non-limiting examples and may be applied in various situations. Additionally, it will be understood that other implementations not explicitly described herein may also fall within the scope of the claims set forth below. Systems and methods for current modulation based on ambient light for a transparent display may result in any or all of the technical effects mentioned above, as well as various additional and/or alternative technical effects and benefits that will be described and/or made apparent below.

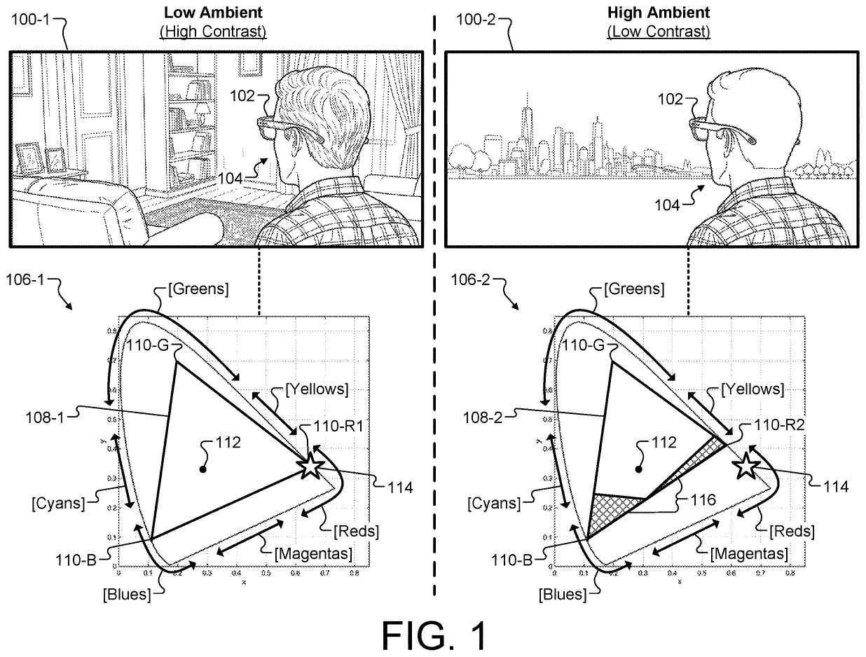

FIG. 1 illustrates an example implementation in which a transparent display is operated by a user in different ambient-light conditions. As shown, FIG. 1 includes a first scenario 100-1 associated with a relatively low ambient level of light (“Low Ambient”) and a second scenario 100-2 associated with a relatively high ambient level of light (“High Ambient”). As will be described, these scenarios conceptually illustrate that different ambient conditions may favor different profiles, different currents for a primary color, and different color spaces displayable by a transparent display 102.

In both scenarios 100-1 and 100-2, a transparent display 102 is shown to be worn by a user 104. Transparent display 102 may be implemented in any suitable form, including as part of an extended reality display system, a head-mounted display, glasses, goggles, or another wearable or non-wearable display device. In the illustrated example, user 104 may view different environments through transparent display 102 while transparent display 102 presents virtual content. Because transparent display 102 is transparent, light from the environment remains visible to user 104 and is additive to display light generated by transparent display 102. As a result, visibility of displayed content may vary with the ambient level of light in the environment.

As shown, first scenario 100-1 may represent a lower-ambient environment, such as an indoor environment or another environment in which contrast between display light and environmental light is relatively high. In such a scenario, transparent display 102 may be capable of presenting content from a first color space having a relatively large extent in one or more chromaticity directions. In contrast, second scenario 100-2 may represent a higher-ambient environment, such as a bright outdoor environment, in which environmental light raises a luminance floor and reduces the practical visibility of at least some displayed colors. In such a scenario, transparent display 102 may be operated according to a different profile so as to present content from a second color space that is better suited for the higher ambient level.

As shown, first scenario 100-1 is associated with a first chromaticity diagram 106-1, and second scenario 100-2 is associated with a second chromaticity diagram 106-2. Each chromaticity diagram may represent a color space, shown as a triangle in relation to a broader range of human color perception. In the illustrated example, the outer horseshoe-shaped boundary of each diagram may represent a chromaticity boundary of the colors perceivable by the human visual system (e.g., a chromaticity diagram such as a CIE-1931 diagram). In these diagrams, colors nearer the perimeter may correspond to more saturated colors (e.g., deeper and richer colors) and colors nearer the center may correspond to less saturated colors (e.g., closer to white). While color is not shown in the line drawing of FIG. 1, it will be understood that labels positioned around the perimeter (e.g., labels corresponding to reds, greens, blues, cyans, yellows, and magentas, etc.) are illustrative of general chromaticity regions and are not intended to limit the disclosed principles to any particular color model or coordinate system.

Within first chromaticity diagram 106-1, a first color space 108-1 (illustrated as a triangle) may be defined by a plurality of primary colors including a green primary color 110-G, a blue primary color 110-B, and a red primary color 110-R1. In some implementations, this red primary color 110-R1 may be a native primary color of transparent display 102 under a first current or analog current regime associated with a first profile. In other words, in this lower-ambient first scenario 100-1, red primary color 110-R1 may correspond to a relatively longer-wavelength and more saturated red, thereby allowing first color space 108-1 to include a relatively saturated red-side region.

A white point 112 may also be defined for first color space 108-1. White point 112 may correspond to a desired achromatic point for transparent display 102, such as D65 or another suitable white point. In some implementations, maintaining this white point 112 across different operating conditions may be beneficial because neutral colors and shared colors may remain visually stable even when one or more primary colors shift. Accordingly, white point 112 is shown in a generally central region of first chromaticity diagram 106-1 as a point that may be maintained notwithstanding other changes in the color space.

FIG. 1 also shows a target color 114, indicated by a star shape coincident with red primary color 110-R1. In the illustrated example, target color 114 is a highly saturated red, and, as shown in the first scenario 100-1, first color space 108-1 may encompass this target color 114 when there is sufficient contrast. In other words, transparent display 102 may present target color 114 when the ambient level is low enough for such a saturated color to remain useful and visible. Thus, in lower-ambient conditions, a selected profile may support both satisfactory visibility and a relatively rich color space.

By contrast, second scenario 100-2 may correspond to an ambient condition in which some highly saturated colors are less practically useful because the higher ambient level tends to wash out those colors. This effect is represented in FIG. 1 by shaded areas 116. Shaded areas 116 within a color space 108-2 shown within second chromaticity diagram 106-2 will be understood to represent regions that are difficult to resolve perceptually, insufficiently visible relative to the ambient level, outside a selected color space for the current operating regime, and/or otherwise less useful for presentation in higher-ambient situations such as second scenario 100-2. Thus, while a color may be theoretically desirable in the abstract, the higher ambient level may make that color less suitable for actual use in the environment of second scenario 100-2.

To address this condition, transparent display 102 may be operated according to a profile selected based on the higher ambient level. In the illustrated example, that selected profile may define a different current, such as a higher analog current, for a primary color of the transparent display 102. As a result, the red primary color may shift from the first red primary color 110-R1 shown in the first chromaticity diagram 106-1 to a second red primary color 110-R2 shown in the second chromaticity diagram 106-2 (while, for this example, green primary color 110-G and blue primary color 110-B are shown to remain fixed). In some implementations, second red primary color 110-R2 may correspond to a shorter (e.g., blue-shifted) wavelength as compared to first red primary color 110-R1. For example, where red emitters include micro light-emitting diodes formed using aluminum indium gallium phosphorus semiconductor material, increasing the current may cause a perceptible shift of the red primary color toward a more orange-red chromaticity. While red is used as an example primary color in FIG. 1, similar principles may apply to any suitable primary color or combination of primary colors.

Because the second red primary color 110-R2 is shifted relative to the first red primary color 110-R1, second color space 108-2 may differ from first color space 108-1. In particular, the red-side extent of second color space 108-2 may move inward and/or toward shorter wavelengths relative to the first color space 108-1. Consequently, the target color 114 shown in the first scenario 100-1 is shown to no longer be included within the second color space 108-2 in this higher-ambient second scenario 100-2. While this shift may equate to less vivid and saturated colors being displayed in the bright ambient light of scenario 100-2, this may be an acceptable and advantageous tradeoff because the higher-current operating regime associated with the selected profile may better support visibility of content that remains within the second color space 108-2 under the elevated ambient condition.

As further shown in FIG. 1, although second color space 108-2 may differ from first color space 108-1, white point 112 may remain the same or substantially the same. In some implementations, this may be accomplished by modifying, based on the selected profile, a relationship between values representative of content and drive signals for driving an array of emitters of the transparent display 102 at the current defined by the selected profile. For example, when the current for the red primary color changes and the red primary color correspondingly shifts, the relationship between values representative of content and drive signals may also be modified so as to maintain white point 112 for the color space associated with the selected profile. This may allow shared colors, neutral tones, and other colors within an overlapping region of first color space 108-1 and second color space 108-2 to remain more visually consistent across different ambient conditions.

In some examples, the shift between first red primary color 110-R1 and second red primary color 110-R2 may be perceptually significant. For instance, a perceptual color difference between the first red primary color 110-R1 and the second red primary color 110-R2 may satisfy a threshold such as at least ΔE₀₀=20, though any other suitable threshold may be used. Accordingly, when the ambient level changes enough to cause selection of a different profile, user 104 may perceive a noticeable change in saturation or hue for certain colors, particularly colors near an edge of the color space. Even so, disclosed implementations may provide an advantageous overall result because the transparent display 102 may shift to an operating regime better matched to the current environment while preserving the desired white point and improving practical visibility.

FIG. 1 accordingly provides an intuitive overview of the disclosed principles. In lower-ambient conditions, transparent display 102 may operate according to a first profile associated with a first current for a primary color and may present from the first color space 108-1 that includes relatively saturated colors. In higher-ambient conditions, transparent display 102 may operate according to a second profile associated with a second current for the primary color and may present from a second color space 108-2 that differs from the first color space 108-1. By selecting the profile based on the ambient level and by correspondingly modifying the relationship between values representative of content and drive signals to maintain the white point 112, the transparent display 102 may provide a useful balance between visibility and color performance across different environments.

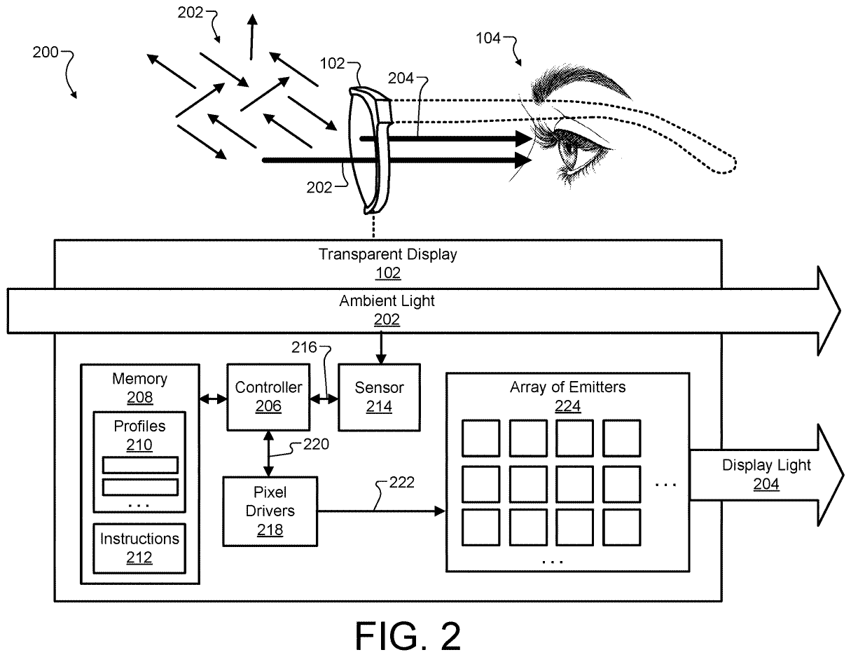

FIG. 2 shows an implementation of a display system 200 that includes transparent display 102 and is used by a user 104 in an environment that provides ambient light 202, while transparent display 102 generates display light 204 for presentation of content. Display system 200 may be implemented in any suitable form, including as an extended reality (XR) display system that includes a head-mounted display. In the illustrated example, FIG. 2 includes an upper view and a lower block-diagram view. The upper view shows a physical representation of user 104 wearing transparent display 102 in the environment. In that upper view, ambient light 202 is illustrated by a plurality of scattered arrows and one long arrow representing environmental light that passes through transparent display 102 toward user 104, while display light 204 is illustrated as light generated by transparent display 102 for presentation to user 104. This illustrates that transparent display 102 may be an optical see-through display such that ambient light 202 remains visible through transparent display 102 and display light 204 is additive to ambient light 202. As discussed above, this additive light behavior may make the practical visibility of displayed content depend on ambient conditions.

FIG. 2 further shows a block diagram of example components that may be included in display system 200 to support operation of transparent display 102. In the illustrated example, display system 200 includes a controller 206, a memory 208, a plurality of profiles 210, instructions 212, a sensor 214, ambient levels 216, pixel drivers 218, drive signals 220, analog current 222, and an array of emitters 224. It will be understood that transparent display 102 may itself form part of display system 200, and one or more of these illustrated components may be implemented within transparent display 102, within a housing or frame associated with transparent display 102, and/or elsewhere in display system 200, such as in a companion device carried by user 104. Thus, the lower block-diagram view is schematic and is not intended to require any particular physical partitioning of components within display system 200. These components may be communicatively coupled in any suitable manner to support selection of a profile based on ambient levels 216 and operation of transparent display 102 according to the selected profile. Each of these components will now be described in more detail.

Controller 206 may be implemented by any suitable processor, display engine, graphics processor, control circuitry, or combination of such components. Memory 208 may be implemented by any suitable non-transitory computer-readable medium storing instructions 212 and data associated with profiles 210. In some implementations, instructions 212 may cause controller 206 to receive ambient levels 216, select one of profiles 210 based on ambient levels 216, modify a relationship between values representative of content and drive signals 220 based on the selected profile, and use drive signals 220 to cause pixel drivers 218 to drive the array of emitters 224 accordingly.

Profiles 210 may be implemented as data structures, lookup entries, operating modes, tables, records, or other representations of different operating regimes for transparent display 102. In some examples, a given profile may define or otherwise be associated with analog current 222 for the primary colors of a color space displayable by transparent display 102. A given profile may additionally define or otherwise be associated with a relationship between values representative of content and drive signals 220, a white point treatment, a global brightness behavior, a target contrast or target contrast ratio, and/or any other suitable operating characteristics. In this way, profiles 210 may permit display system 200 to adapt both current behavior and mapping behavior to different ambient conditions.

Sensor 214 may be implemented by an ambient light sensor, an image sensor, an array of photosensors, and/or another suitable sensor arrangement. Sensor 214 may detect ambient light 202 and provide ambient levels 216 to controller 206. Ambient levels 216 may represent brightness, luminance, illuminance, a spatial distribution of light, a temporal change in light, and/or another suitable characterization of the environment. In some implementations, sensor 214 may determine a single representative ambient level for the environment, such as a global value used to select one profile for transparent display 102 as a whole. In other implementations, sensor 214 may provide a more spatially resolved characterization of the environment. For example, an image sensor or array of photosensors may detect different ambient levels for different portions of a field of view or for different regions corresponding to transparent display 102. Controller 206 may accordingly determine ambient levels 216 for multiple regions and may use those ambient levels 216 to select profiles, transitions, and/or other operating behavior on a regional basis. In further implementations, sensor 214 may additionally characterize a spectral composition or color characteristic of ambient light 202, which may also be used in selecting a profile or otherwise controlling operation of display system 200.

Pixel drivers 218 may be implemented by backplane circuitry, current-control circuitry, switching circuitry, and/or other circuitry configured to drive the array of emitters 224. Drive signals 220 may include digital, analog, timing, enable, pulse-width modulation, and/or other control information derived from content and from the selected profile. In some examples, pulse-width modulation included in drive signals 220 may be used to implement global brightness control and/or content-dependent brightness control within an operating regime defined by analog current 222. Analog current 222 may be distinguished from drive signals 220 in that analog current 222 may define a hardware operating regime for one or more primary colors, while drive signals 220 may implement content-dependent control within that operating regime.

The array of emitters 224 may include any suitable emitters, including micro light-emitting diodes (microLEDs). In some implementations, emitters associated with a red primary color may include aluminum indium gallium phosphorus (AlInGaP) emitters whose chromaticity shifts with current. Thus, when controller 206 selects different profiles 210 based on ambient levels 216, pixel drivers 218 may apply different analog currents 222 to the array of emitters 224, thereby causing transparent display 102 to present from different color spaces under different ambient conditions. Controller 206 may also modify the relationship between values representative of content and drive signals 220 so as to maintain a white point for the color space associated with a selected profile.

FIG. 2 accordingly illustrates one example of an end-to-end control architecture in which display system 200 senses ambient conditions, selects a profile, modifies drive behavior, and drives the array of emitters 224 in a manner that adapts transparent display 102 to the environment.

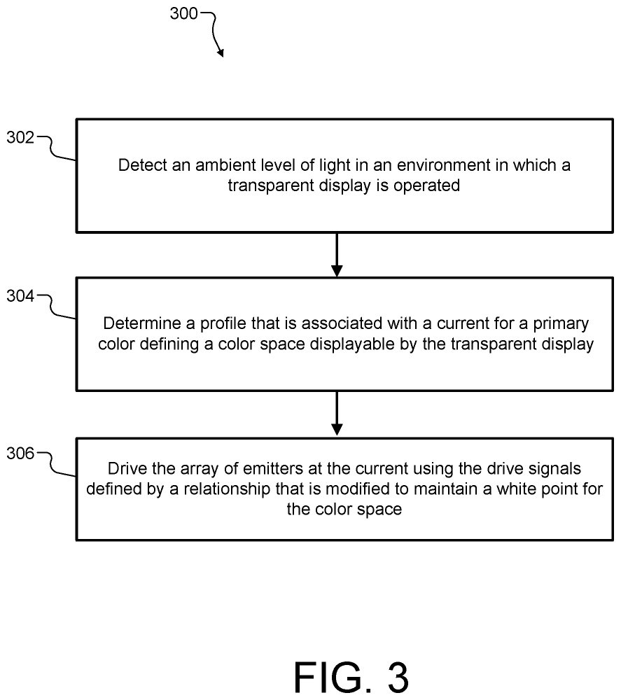

FIG. 3 shows an illustrative method 300 for performing current modulation based on ambient light for a transparent display. In some implementations, method 300 may be performed by a display system such as display system 200, by a transparent display within such a display system (e.g., transparent display 102), by a controller such as controller 206, by a combination of a controller, memory, sensor, and pixel drivers, and/or by any other suitable system or component. Although FIG. 3 shows operations 302, 304, and 306 in a particular order, it will be understood that in some implementations, one or more operations of method 300 may be omitted, repeated, combined, subdivided, performed in parallel, and/or performed in another suitable order consistent with the principles described herein.

Method 300 may be used to adapt operation of a transparent display to ambient conditions in an environment in which the transparent display is operated. As discussed above, because the transparent display is optically see-through, ambient light from the environment may remain visible through the transparent display and may be additive to display light generated by the transparent display. As a result, different ambient conditions may favor different currents for respective primary colors and different color spaces displayable by the transparent display. Method 300 illustrates one example high-level logical sequence by which the display system may respond to such ambient conditions.

At operation 302, the display system may detect an ambient level of light in an environment in which the transparent display is operated. In some implementations, detecting the ambient level may involve using a sensor, such as an ambient light sensor, an image sensor, an array of photosensors, or another suitable sensor arrangement. As noted above, the detected ambient level may correspond to a single value for an overall environment, a plurality of values for respective regions of the environment, a temporal change in brightness, a spectral characteristic, and/or another suitable characterization of ambient light.

Detecting the ambient level at operation 302 may provide an input by which the display system may determine how the transparent display is to be operated under current environmental conditions. For example, a relatively low ambient level may indicate that the transparent display may effectively present a larger or more saturated color space, while a relatively high ambient level may indicate that a different operating regime is appropriate to improve practical visibility. In this way, detecting the ambient level may provide environmental information used to trigger later profile determination and corresponding current and mapping updates.

At operation 304, the display system may determine, based on the ambient level detected at operation 302, a profile from a plurality of profiles associated with the transparent display. In some implementations, determining the profile may include determining (or selecting) the profile directly from the ambient level, responsively to the ambient level, using the ambient level together with one or more additional inputs, and/or according to any suitable threshold, criterion, rule, or decision logic.

The profile determined at operation 304 may be associated with an analog current for a primary color defining a color space displayable by the transparent display. For example, one profile may be associated with a first current for a red primary color that defines a first color space displayable by the transparent display under a first ambient condition, while another profile may be associated with a second current for the red primary color that defines a second color space displayable by the transparent display under a second ambient condition. In some implementations, the selected profile may additionally be associated with a target contrast, a white point treatment, a global brightness behavior, and/or another operating characteristic.

At operation 306, the display system may drive, based on the profile and using drive signals defined by a relationship that is modified to maintain a white point for the color space, the array of emitters at the current associated with the profile. In some implementations, the relationship may be a relationship between brightness values representative of or otherwise associated with content to be displayed and the drive signals used for driving the array of emitters at the current associated with the selected profile. These brightness values associated with the content may include digital pixel values, RGB values, grayscale values, luminance-related values, and/or other values corresponding to content to be presented. The relationship may be implemented in any suitable manner, such as by a lookup table, a transform, a matrix operation, a function, an algorithm, circuitry, and/or another suitable mapping arrangement.

In some implementations, the relationship used at operation 306 may be modified to maintain a white point for the color space associated with the selected profile determined at operation 304. For example, if the profile change causes a current for a primary color to change and the corresponding primary color to shift, the relationship may be modified by changing one or more ratios among drive signals for different channels so that a desired white point, such as D65, remains the same or substantially the same. Thus, the relationship (e.g., a mapping between brightness values associated with content to be displayed and the drive signals used for the driving of the array of emitters) may be modified in coordination with the current behavior so that the transparent display transitions between profiles in a controlled manner rather than merely changing the current without corresponding color compensation.

Driving the array of emitters at operation 306 may involve using pixel drivers (e.g., pixel drivers 218) to drive the array of emitters using the drive signals while applying the current associated with the profile that has been selected (or otherwise determined) at operation 304. As discussed above, the current may define a hardware operating regime for a primary color, while the drive signals may implement content-dependent control within that operating regime, such as by using pulse-width modulation and/or other drive control techniques.

By driving the array of emitters at the current using drive signals defined by the relationship as modified, the display system may cause the transparent display to present content from the color space associated with the selected profile while maintaining a white point for that color space. In some implementations, this may allow the transparent display to present richer or more saturated colors in lower-ambient conditions and to present a different, visibility-oriented color space in higher-ambient conditions. Method 300 may thereby provide a coordinated sequence in which ambient conditions are detected, a profile is determined, a relationship (e.g., mapping) is updated, and the array of emitters are driven according to the determined profile and corresponding relationship.

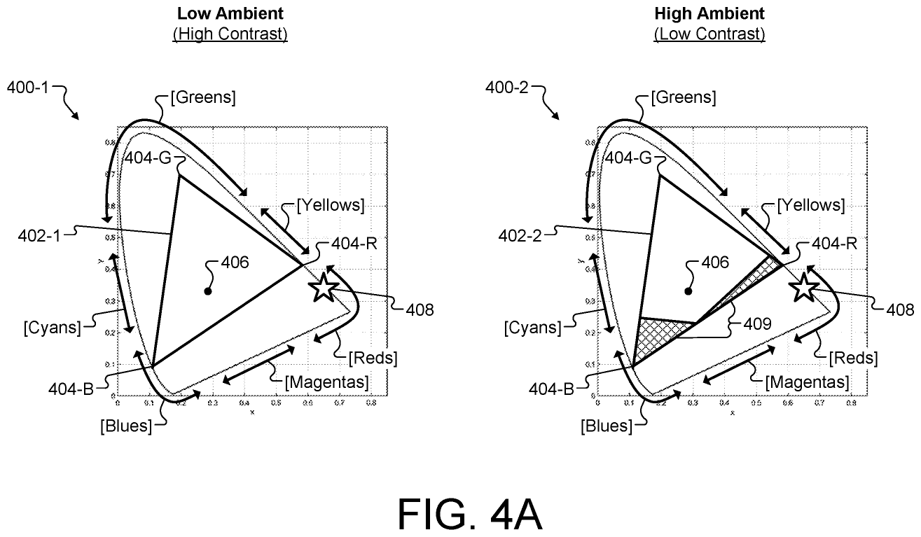

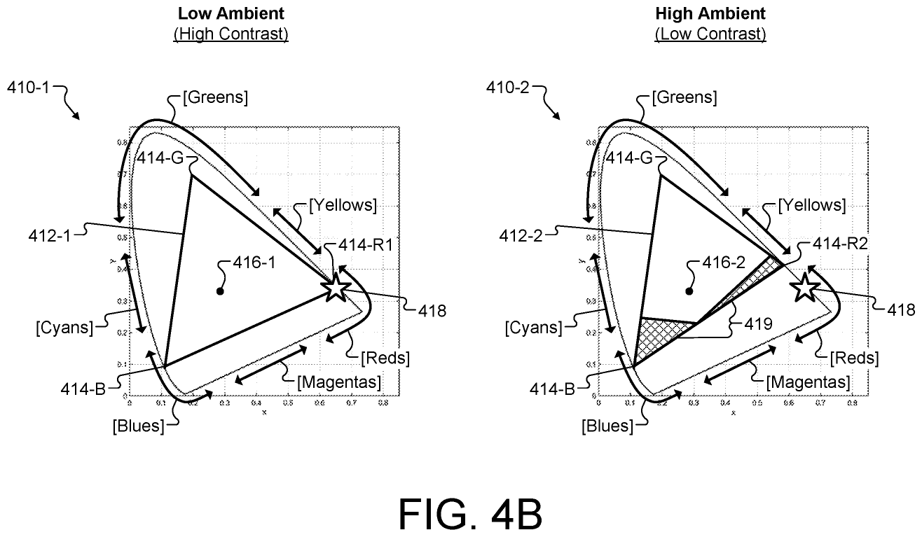

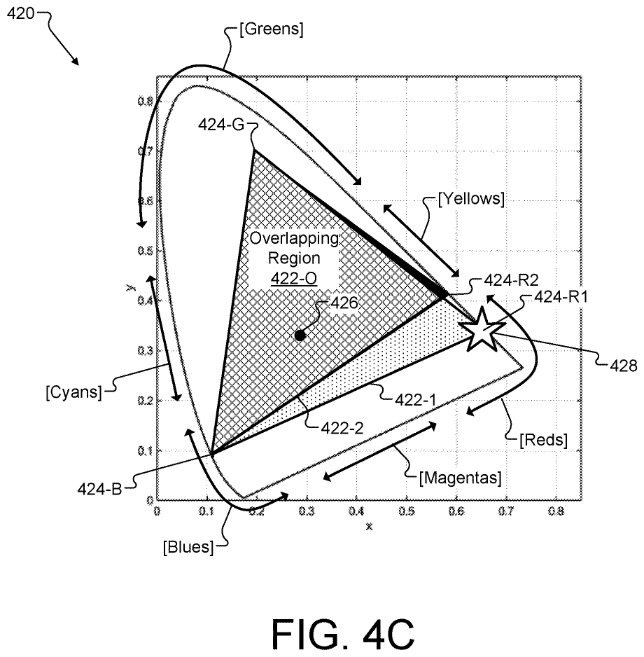

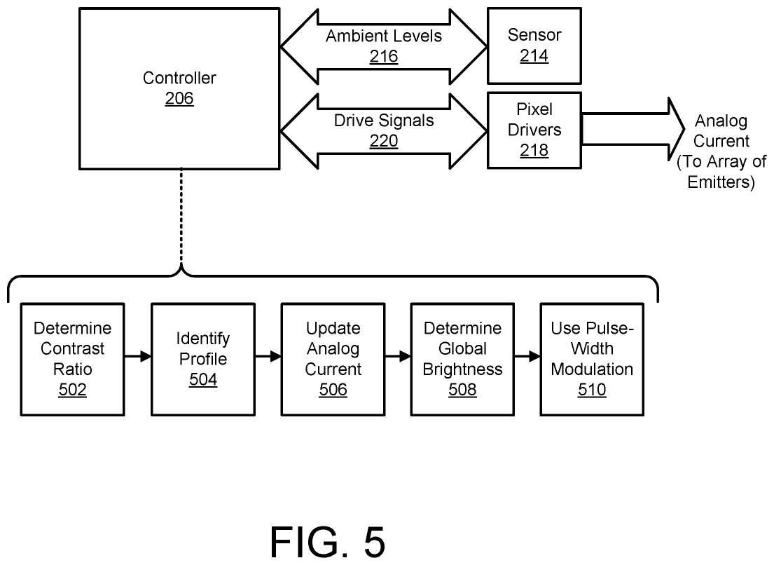

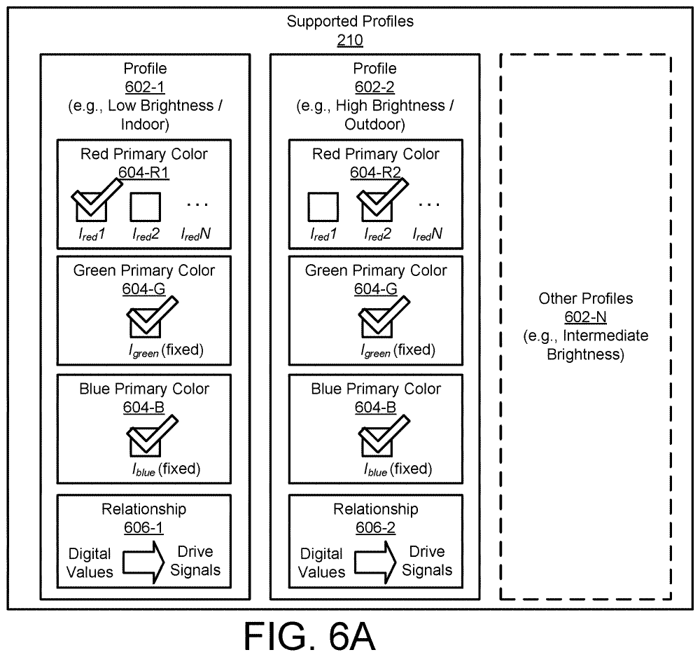

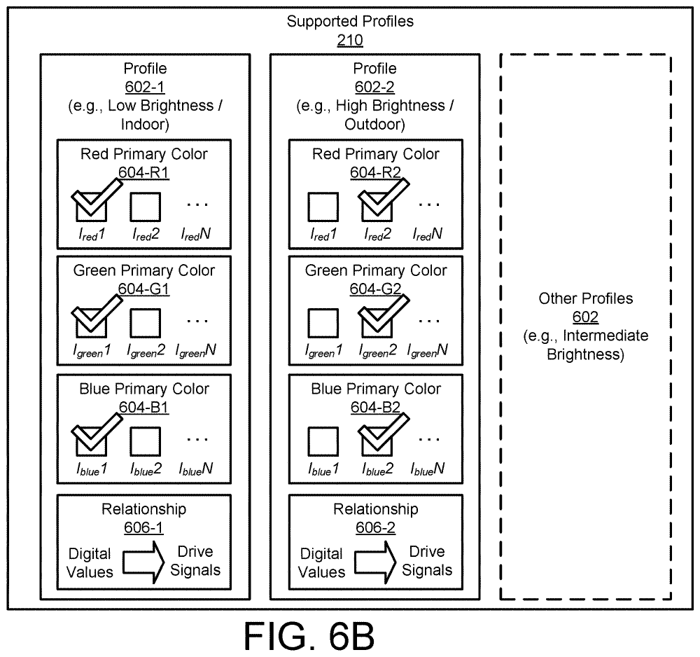

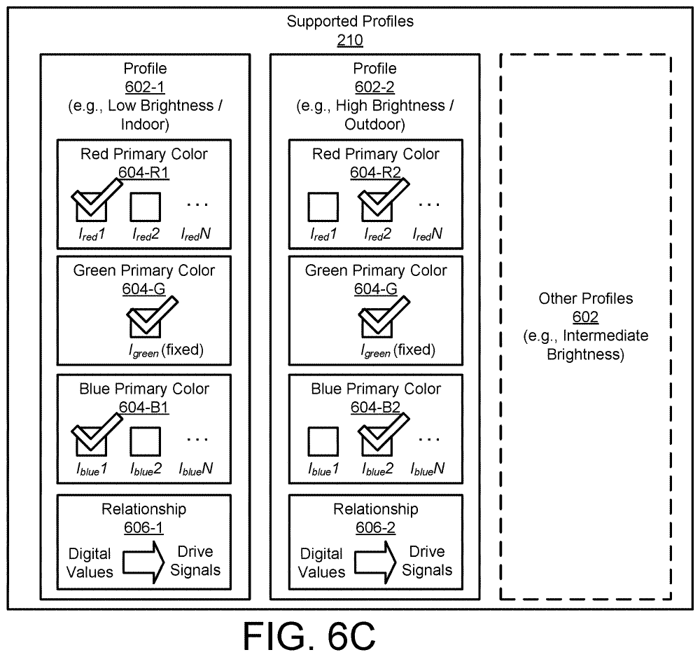

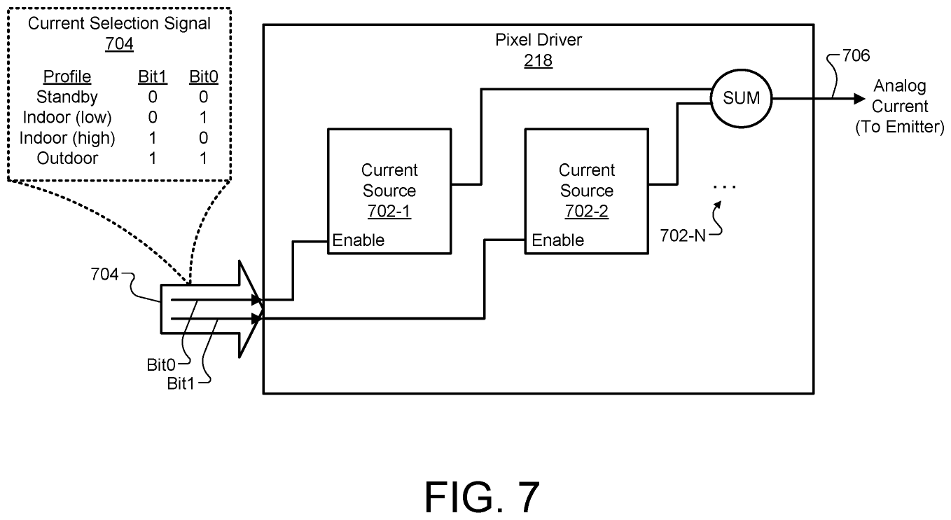

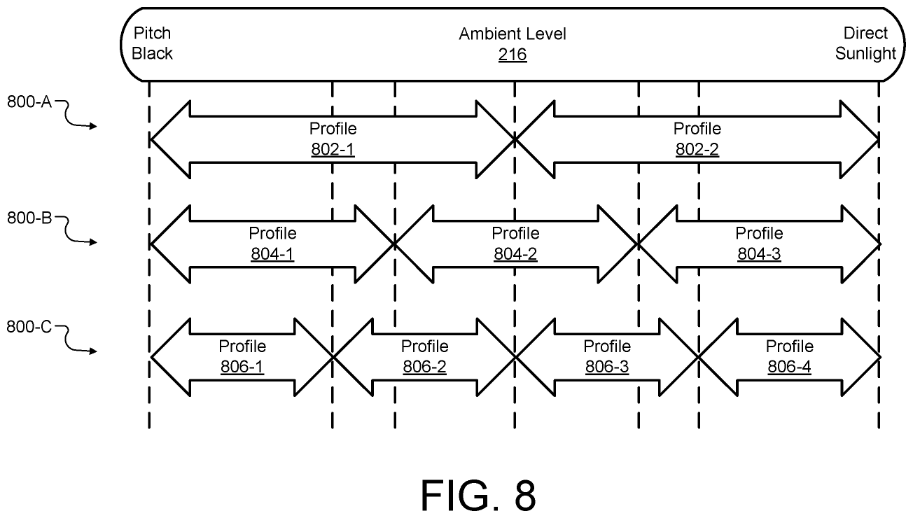

Having described an example system architecture and an example high-level method, the description will now turn to several figures that further illustrate particular contours of the disclosed solutions. More particularly, FIGS. 4A-4C provide a more detailed discussion of how different current regimes may correspond to different primary colors and different color spaces for a transparent display, FIG. 5 provides a more detailed example of controller logic for selecting and applying a profile, FIGS. 6A-6C provide examples of profile organization and contents, FIG. 7 provides an example of pixel-driver hardware for implementing different current regimes, and FIG. 8 provides examples of how different ambient conditions may be mapped to profiles or operating modes. These later figures may be understood as building on the system-level and method-level discussion above to show additional implementation details, non-limiting examples, and potential refinements.

FIGS. 4A-4C provide a useful conceptual framework for understanding why different profiles may be advantageous in different ambient conditions. As described above, a transparent display may operate in an additive-light setting in which ambient light from an environment remains visible through the display and combines with display light. Because different ambient conditions may favor different tradeoffs between visibility and saturation, and because one or more primary colors may shift as the current changes, a display system may improve overall operation by selecting different profiles associated with different currents and by correspondingly modifying the relationship between values representative of content and drive signals. In the discussion that follows, supported color spaces for transparent displays are illustrated by regions bounded by primary colors within chromaticity diagrams (i.e., triangular regions formed by vertices representing three native primary colors red, green, and blue). The illustrated regions may be understood as examples of color spaces displayable by the transparent display under different operating conditions, similarly as described above in relation to FIG. 1. As with other chromaticity diagrams described herein, the outer horseshoe-shaped boundary may represent a broader range of human color perception, while the illustrated regions within that boundary may represent color spaces displayable by the transparent display under particular operating conditions.

FIG. 4A illustrates an example comparison associated with a fixed-current approach. In the illustrated example, FIG. 4A includes a first scenario 400-1 associated with low ambient (high contrast) light, where a first color space 402-1 is used. As shown, first color space 402-1 may be formed by a blue primary color 404-B, a green primary color 404-G, and a red primary color 404-R. Color space 402-1 is shown to include a white point 406, and to not extend to a reference color 408 (indicated by a star shape) that represents a deep red color that is visible to the human visual system but external to color space 402-1. FIG. 4A also shows a second scenario 400-2 associated with high ambient (low contrast) light, where a second color space 402-2 is used. As shown, second color space 402-2 may be formed by the same blue primary color 404-B, the same green primary color 404-G, and the same red primary color 404-R. Color space 402-2 is also shown to include the same white point 406, and to likewise not extend to the reference color 408. In other words, in this example, the currents and resultant primary colors, color space, and white points may be fixed independently from the ambient environment situation, such that the same color space is available for presenting content in both scenarios 400-1 and 400-2, regardless of the amount of ambient light.

In first scenario 400-1, the environment may permit relatively high practical contrast for virtual content. Under such conditions, transparent display may be capable of supporting a relatively larger or more saturated color space than the one represented by first color space 402-1. However, FIG. 4A shows a fixed-current design that is unable to take advantage of that opportunity. Instead, because the current driven to the red emitters is fixed in this example, the system may remain configured according to a higher-current regime selected to support visibility in bright ambient conditions such as those represented by scenario 400-2. In other words, because the current is fixed in this example, color spaces 402-1 and 402-2 may represent the same fixed color space being used in both scenarios 400-1 and 400-2, regardless of the ambient-light condition. As such, the low ambient scenario 400-1 leaves some color saturation and power efficiency potential untapped in an effort to ensure that the color space will be visible in the high ambient scenario 400-2. As mentioned above, this can be seen in first scenario 400-1 by the fact that reference color 408 is excluded from color space 402-1 even though the lower-ambient environment would otherwise allow that saturated reference color to be useful and visible.

In contrast, high ambient scenario 400-2 of FIG. 4A illustrates why a designer might nevertheless select the fixed higher-current regime. In a relatively bright environment, the shorter-wavelength red associated with red primary color 404-R may be an acceptable or even useful tradeoff because highly saturated colors near reference color 408 may be less practically resolvable against the elevated ambient light floor. Under these conditions, second color space 402-2 is an efficient tradeoff given the visibility demands of the environment. Indeed, shaded regions 409 represent colors that, given the high ambient levels in scenario 400-2, are likely to be difficult or impossible for the human visual system to resolve anyway. As shown, even red primary color 404-R in color space 402-2 is in the shaded regions 409, meaning that vivid reds will be difficult to reproduce under the conditions anyway. However, the white point 406 is at least visible and able to be the same as in scenario 400-1, such that many less saturated colors will still be able to be presented in the bright ambient environment. If a fixed color space had been selected that tried to incorporate reference color 408, virtually all red components of the content would be in a shaded area (unresolvable to the human visual system), and even the white point could be in a shaded area, severely reducing the perceived quality of the display and the fidelity of the image presented to the user in the high-ambient environment.

Thus, FIG. 4A illustrates that a fixed-current design may leave saturation potential unleveraged in lower-ambient conditions. While such a design may still maintain the same white point 406, the design may do so while unnecessarily constraining the available color space in lower-ambient scenarios. This thus shows the limitation of a one-size-fits-all approach: a color space appropriate for bright ambient operation may also be imposed in dimmer environments where a richer color space would have been available and desirable.

FIG. 4B illustrates an example comparison associated with a profile-based approach of the kind described herein. In the illustrated example, FIG. 4B includes a first scenario 410-1 and a second scenario 410-2. First scenario 410-1 may be understood as illustrating operation of a transparent display in a first ambient-light condition (e.g., a low ambient environment similar to that of scenario 400-1 above), and includes a first color space 412-1, a first red primary color 414-R1, a first white point 416-1, and a reference color 418. Second scenario 410-2, in contrast, may be understood as illustrating operation of the transparent display in a second ambient-light condition (e.g., a high ambient environment similar to that of scenario 400-2 above), and includes a second color space 412-2, a second red primary color 414-R2, a second white point 416-2, and a shaded region 419. As with FIG. 4A, FIG. 4B shows that blue primary color 414-B and green primary color 414-G may be the same in this example of FIG. 4B as they help define both color spaces 412-1 and 412-2. In contrast with FIG. 4A, which illustrates use of the same fixed current in different ambient-light conditions, FIG. 4B illustrates that the display system may instead select different profiles for different ambient-light conditions such that the transparent display may operate with different currents, different primary colors, and different color spaces in different scenarios.

As shown, scenario 410-1 may correspond to a relatively low ambient level of light. In scenario 410-1, the display system may select a first profile associated with a first current for red primary color 414-R1 (as well as currents for the green and blue primary colors, which will be less emphasized in the following description, as only the red primary may change in this example). As a result, the transparent display may present from first color space 412-1. In the illustrated example, red primary color 414-R1 may correspond to a relatively longer-wavelength and more saturated red than second red primary color 414-R2, such that first color space 412-1 extends farther in a red-side direction. To wit, reference color 418 is shown to be included within first color space 412-1, even while (like color space 402-2 above), it is shown to be excluded from color space 412-2. Thus, in first scenario 410-1, the transparent display may present reference color 418 and other relatively saturated colors that may be useful and visible in the lower-ambient environment.

Scenario 410-2 may then correspond to a relatively high ambient level of light. In scenario 410-2, the display system may select a second profile associated with a second current for red primary color 414-R2 (as well as, again, being associated with the fixed currents for the green and blue primary colors 414-G and 414-B in this example). In some implementations, the second current may be higher than the first current, and red primary color 414-R2 may correspond to a shorter (“blue-shifted”) wavelength as compared to the wavelength of the first red primary color 414-R1. As a result, the transparent display may present from the second color space 412-2 rather than the first color space 412-1. In the illustrated example, color space 412-2 is reduced or shifted in the red-side direction relative to color space 412-1, such that reference color 418 now is shown to fall outside color space 412-2. Shaded regions 419, like shaded regions 409 described above, will be understood to represent colors that are available in scenario 410-1 but that are not included within color space 412-2 in the second scenario 410-2.

Unlike the fixed-current example of FIG. 4A, the reduction represented by shaded region 419 in FIG. 4B may reflect an intentional adaptation rather than an unnecessary limitation. In particular, in the higher-ambient environment of scenario 410-2, the relatively saturated colors near first red primary color 414-R1 may be less practically useful because ambient light may wash out those colors or otherwise make them difficult to perceive. Accordingly, the display system may trade some color-space extent for improved visibility by selecting the second profile in second scenario 410-2, while still selecting the first profile in first scenario 410-1 to preserve richer color capability when ambient conditions allow. FIG. 4B thus illustrates that the disclosed techniques may adapt operation of the transparent display to different ambient-light conditions instead of forcing one compromise operating state to apply in all conditions.

FIG. 4B also illustrates that the disclosed adaptation may involve more than merely changing digital brightness. Rather, the display system may change the current associated with a primary color, thereby changing the primary color itself and the color space displayable by the transparent display. In some implementations, this may occur where emitters associated with a red primary color include micro light-emitting diodes formed using aluminum indium gallium phosphorus semiconductor material, such that increasing current may shift the red primary color toward a shorter wavelength. Although the color space may differ between first scenario 410-1 and second scenario 410-2, the display system may modify the relationship between values representative of content and drive signals so as to maintain first white point 416-1 and second white point 416-2 at the same or substantially the same intended white point. In this way, neutral colors and other shared colors may remain more visually stable across profile changes even though the color-space boundary changes.

In some implementations, the shift between first red primary color 414-R1 and second red primary color 414-R2 may be perceptually significant. For example, a perceptual color difference between the first red primary color 414-R1 and the second red primary color 414-R2 may satisfy a threshold such as an ΔE₀₀ of at least 20, though other thresholds may be used in other implementations. As a result, when ambient conditions change enough to cause selection of a different profile, a user may perceive a noticeable difference for certain colors near an edge of the color space. This perceptible change may be a consequence of the same profile-based hardware adaptation that allows the transparent display to better match the ambient environment.

FIG. 4C illustrates an overlay view to help demonstrate how color consistency may be maintained for shared colors across different profiles. In the illustrated example, FIG. 4C includes an overlay diagram 420, a first color space 422-1, a second color space 422-2, an overlapping region 422-O, a first red primary color 424-R1, a second red primary color 424-R2, a blue primary color 424-B, a green primary color 424-G, a white point 426, and a reference color 428. First color space 422-1 is illustrated with a spotted fill pattern and may be defined by vertices at first red primary color 424-R1, blue primary color 424-B, and green primary color 424-G. Second color space 422-2 is illustrated with a black fill pattern and may be defined by vertices at second red primary color 424-R2, blue primary color 424-B, and green primary color 424-G. Only relatively small portions of these color spaces can be seen with the indicated fill patterns since an overlapping region 422-O, where color space 422-1 and color space 422-2 overlap, is illustrated with a cross-hatched fill pattern. Overlay diagram 420 may thus be understood as superimposing color spaces associated with different profiles on a common chromaticity diagram, so that shared and non-shared portions of those color spaces are visible together.

As described above for color spaces 412-1 and 412-2, respectively, color space 422-1 may correspond to a first profile, such as a lower-current profile, while color space 422-2 may correspond to a second profile, such as a higher-current profile. Because the red primary color may shift as current changes, red primary color 424-R1 and red primary color 424-R2 are shown to occupy different chromaticity locations, while blue primary color 424-B and green primary color 424-G may remain the same or may differ less significantly. The intersection of color space 422-1 and second color space 422-2 is represented by overlapping region 422-O, which will be understood to include colors that are available in both profiles notwithstanding the current-driven shift in the red primary color.

For colors within overlapping region 422-O, the display system may modify the relationship between values representative of content and drive signals so that those colors appear equivalent, or substantially equivalent, across different profiles. In some implementations, this may include modifying a ratio of drive signals associated with different primary colors when transitioning from one profile to another. Such a modification may compensate for the change from the first profile (with red primary color 424-R1) to the second profile (with red primary color 424-R2) while preserving a desired chromaticity for many shared colors. White point 426 provides an important example of one such shared color. In some implementations, white point 426 may correspond to a desired reference white point, such as D65, and the display system may modify the relationship between values representative of content and drive signals so as to maintain white point 426 for both color space 422-1 and color space 422-2.

FIG. 4C also illustrates that not every color need be preserved identically across profiles. Reference color 428 is shown outside overlapping region 422-O. In such a case, reference color 428 may be available in one profile but unavailable in another profile. For example, reference color 428 may be available when the display system selects a lower-current profile associated with color space 422-1, but unavailable when the display system selects a higher-current profile associated with color space 422-2. This may be acceptable because the higher-current profile may be selected for an ambient-light condition in which reference color 428 is less practically useful or less likely to be perceptible. Accordingly, FIG. 4C shows that the disclosed techniques may preserve consistency for shared colors, including a desired white point, while still allowing profile-dependent differences for colors outside overlapping region 422-O.

Taken together, FIGS. 4B and 4C illustrate how the display system may adapt a transparent display to different ambient-light conditions while preserving favorable behavior for shared colors. FIG. 4B shows that different profiles may be selected in different ambient-light conditions so that the transparent display may present from different color spaces under different conditions. FIG. 4C shows that, within overlapping portions of those color spaces, the display system may modify the relationship between values representative of content and drive signals so that shared colors may appear equivalent, and a desired white point may be maintained across different profiles.

FIG. 5 illustrates one example of controller logic that may be used to apply a selected profile in response to ambient conditions. As described above in relation to FIG. 2, in this illustrated example, controller 206 may receive information from sensor 214, including ambient levels 216, and may provide drive signals 220 to pixel drivers 218, which may then drive the array of emitters with analog currents appropriate to the selected profile. FIG. 5 may thus be understood as providing a more detailed view of how the display system processes environmental information and determines not only an analog current associated with a selected profile, but also additional drive parameters that together govern how content is ultimately presented by the transparent display. In this way, FIG. 5 helps show that emitted brightness for a given pixel may depend not merely on the selected analog current, but also on other factors such as a global brightness value and content-sensitive pulse-width modulation behavior.

In some implementations, controller 206 may use ambient levels 216 to determine a target contrast at operation 502. The target contrast may correspond to a desired contrast ratio associated with suitable visibility in the current environment. For example, when ambient levels 216 indicate a relatively dim environment, controller 206 may determine a relatively higher target contrast. When ambient levels 216 indicate a relatively bright environment, controller 206 may determine a different target contrast that is appropriate for the elevated ambient-light floor. In some implementations, controller 206 may select the target contrast from a discrete set of target contrast values or target contrast ratios associated with different ambient-light bands.

At operation 504, controller 206 may identify a profile based on the target contrast and/or based directly on ambient levels 216. In some implementations, the identified profile may satisfy a criterion associated with the current environment, such as a brightness criterion, a contrast criterion, a power criterion, or another operating criterion. The identified profile may define or otherwise be associated with a current for a primary color defining a color space displayable by the transparent display, as well as a relationship between values representative of content and drive signals.

At operation 506, the display system may update an analog current associated with the identified profile. In some implementations, updating the analog current may change a hardware operating regime for one or more emitters and may thereby change a primary color and the color space displayable by the transparent display. However, the analog current need not by itself fully determine how bright a given pixel will ultimately appear. Rather, the analog current may establish a current regime or brightness headroom within which additional drive parameters may operate. Thus, operation 506 may place the display hardware into an operating state appropriate for the current environment before one or more further controls are applied to determine final emitted brightness for particular content.

At operation 508, the display system may determine a global brightness to be used with the updated analog current. In some implementations, the global brightness may be determined to achieve the target contrast ratio relative to ambient levels. The global brightness may represent an overall brightness setting or scaling applied more broadly across the transparent display, such as across an image, frame, display region, or other presented content. Because the analog current may already have been updated at operation 506, the display system may determine the global brightness in view of the operating regime established by that analog current. In this way, operation 508 may provide a further layer of brightness control that works together with, but is distinct from, the analog current associated with the selected profile.

At operation 510, the display system may use pulse-width modulation to implement the determined global brightness and to present content using drive signals. In some implementations, pulse-width modulation may be content-sensitive such that different pixel values, subpixel values, or other values representative of content may correspond to different pulse widths, duty cycles, or related drive behavior. Thus, the final emitted brightness for a given pixel may depend on multiple factors working together, including the analog current selected for the profile, the global brightness determined for the current environment, and the content-sensitive pulse-width modulation used to present the particular content. In some implementations, pulse-width modulation may be used together with an updated relationship between values representative of content and drive signals so that the transparent display presents content from the color space associated with the selected profile while maintaining a white point for that color space.

FIGS. 6A-6C illustrate example ways in which supported profiles may be organized for use by the display system. In general, each profile may correspond to a different operating regime associated with a current for one or more primary colors and with a corresponding relationship between values representative of content and drive signals. These figures may thus be understood as showing example profile contents that may be stored in memory and selected by a controller based on ambient conditions.

FIG. 6A illustrates a first example in which a first profile 602-1, a second profile 602-2, and additional profiles 602-N (optional in certain implementations, as illustrated by the dashed-line outline) are associated with different currents for a red primary color while a green primary color and a blue primary color remain fixed. More specifically, first profile 602-1 is shown to include a first red primary color 604-R1, a green primary color 604-G, a blue primary color 604-B, and a first relationship 606-1, while second profile 602-2 is shown to include a different red primary color 604-R2, the same green primary color 604-G, the same blue primary color 604-B, and a second relationship 606-2. Relationships 606-1 and 606-2 may represent respective relationships between digital values and drive signals for the corresponding profiles. For example, the digital values may represent content to be displayed, such as pixel values or subpixel values, and the drive signals may represent corresponding control signals used to drive emitters under the current regime associated with the selected profile. Thus, even where profiles differ with respect to current for a primary color, the display system may also use different relationships 606-1 and 606-2 to convert the same or similar digital values into different drive signals so as to maintain a desired white point and/or other display behavior for each profile. Additional profiles 602-N may likewise correspond to additional red primary colors and relationships for other operating regimes, such as intermediate brightness or intermediate ambient-condition profiles.

As shown in FIG. 6A, the red primary color 604-R1, the red primary color 604-R2, and any additional red primary colors of additional profiles 602-N may correspond to different red currents, such as I_{red}1, I_{red}2, and I_{red}N. A check mark beneath a given red current may indicate that the corresponding red current is selected for the associated profile. By contrast, green primary color 604-G and blue primary color 604-B are each shown with a fixed current, such as I_{green} and I_{blue}, which are indicated to be “(fixed)” and therefore show only a single checked box. These currents will thus be understood to remain unchanged across the different profiles in this example. FIG. 6A thus illustrates an implementation in which the display system may modulate current for the red primary color while keeping current for the green and blue primary colors fixed.

FIG. 6B illustrates a second example in which supported profiles 210 include profiles that vary current for all the primary colors red, green, and blue. In the illustrated example, a first profile 602-1 is shown to include a red primary color 604-R1, a green primary color 604-G1, a blue primary color 604-B1, and a relationship 606-1, while a second profile 602-2 is shown to include a different red primary color 604-R2, a different green primary color 604-G2, a different blue primary color 604-B2, and a different relationship 606-2. FIG. 6B again uses the same notation for the changing primary colors (e.g., I_{red}1/I_{red}2, I_{green}1/I_{green}2, and I_{green}1/I_{blue}2) and indicates that other profiles 602 may likewise be included (e.g., for other intermediate brightnesses). In this example, changes between profiles may involve coordinated changes to multiple primary colors, together with corresponding changes to the relationship between digital values and drive signals. Such an implementation may be useful when more than one emitter type exhibits a meaningful current-dependent color shift or when multiple channels are adjusted together to achieve a desired color-space and brightness behavior.

FIG. 6C illustrates a third example in which a first profile 602-1 and a second profile 602-2 differ with respect to a red primary color and a blue primary color, while a green primary color remains fixed. More specifically, first profile 602-1 is shown to include a red primary color 604-R1, a green primary color 604-G, a blue primary color 604-B1, and a relationship 606-1, while a second profile 602-2 is shown to include a different red primary color 604-R2, the same green primary color 604-G, a different blue primary color 604-B2, and a different relationship 606-2. FIG. 6C uses the same notation for the red and blue primary colors (e.g., I_{red}1/I_{red}2 and I_{blue}1/I_{blue}2) while showing the green primary color with a single fixed current (e.g., I_{green}). This example shows that the disclosed techniques are not limited to modulating only one primary color or all primary colors. Rather, different subsets of primary colors may be associated with different currents in different profiles depending on the optical behavior of the associated emitters and the design goals of the display system.

Taken together, FIGS. 6A-6C illustrate that a profile may serve as a compact representation of a display operating state. In some implementations, a profile may identify a current (e.g., an analog current) for one or more primary colors, a color space displayable by the transparent display under that current regime, and a relationship used to map values representative of content into drive behavior that maintains a desired white point. The particular number of profiles and the particular primary colors that are modulated may vary from one implementation to another.

FIG. 7 illustrates an example implementation of a pixel driver 218 that may be used to generate an analog current for driving an emitter. In the illustrated example, pixel driver 218 is shown to include a first current source 702-1 and a second current source 702-2, as well as, possibly, additional current sources 702-N (represented by an ellipsis). Pixel driver 218 is shown to receive a current selection signal 704 that, in this example, includes two bits labeled “Bit0” and “Bit1”. Based on the current selection signal 704, pixel driver 218 is shown to output an analog current 706 to one or more emitters associated with a particular primary color.

In some implementations, current selection signal 704 may be provided by the controller and may indicate which current sources are to be enabled for a selected profile. Thus, the controller may change a combination of enabled current sources within pixel driver 218 to change analog current 706.

The dashed-line box coming from current selection signal 704 in FIG. 7 provides one example of how current selection signal 704 could be used. In the illustrated example, the dashed-line box includes three columns labeled “Profile,” “Bit0,” and “Bit1,” where the Profile column identifies a selected profile and Bit0 and Bit1 indicate whether corresponding current sources are enabled for that profile. For example, for a profile called “Standby” in this example, Bit0 and Bit1 are shown to both be 0, indicating that neither current source is enabled and the supported current may be zero or effectively shut off. Another profile identified as “Indoor (low)” may correspond to a state in which Bit0 is 1 and Bit1 is 0, such that current source 702-1 is enabled to provide a first non-zero current. The profile identified as “Indoor (high)” may then represent a brighter intermediate profile (e.g., brighter than Indoor (low) but still not on the level of full-sun outdoor ambient light) that corresponds to a state in which Bit0 is 0 and Bit1 is 1. This causes current source 702-2 to be enabled, which may provide a greater amount of current than current source 702-1 in this example. Finally, the profile identified as “Outdoor” may correspond to a state in which Bit0 and Bit1 are both 1, such that both current sources 702-1 and 702-2 are enabled together to provide an even larger current based on the combination of enabled current sources. Thus, in this implementation, current selection signal 704 may support four selectable current states (counting the Standby state in which no current source is enabled).

Although FIG. 7 shows multiple selectable current sources, it will be understood that this is only one illustrative implementation. In other implementations, different analog currents for different profiles may be established using any suitable current-setting circuitry, selection logic, decoding logic, multiplexing arrangement, switching network, digital-to-analog conversion circuitry, programmable bias circuitry, and/or other control architecture. For example, rather than enabling fixed current sources in the particular combinations illustrated in FIG. 7, a system may decode one or more control bits in another manner to select among different current branches, to multiplex different current paths, and/or to otherwise generate different current levels for different profiles. Additionally, one or more current sources may be variable rather than fixed, such that a selected profile may correspond to a programmed current level, a bias setting, or another adjustable current parameter instead of only a particular combination of enabled fixed current sources. Accordingly, FIG. 7 should be understood as illustrating one example of how profile-dependent analog-current selection may be implemented, without limiting the disclosed techniques to the specific current-source arrangement shown.

FIG. 8 illustrates example mappings between various possible ambient levels 216 and different profiles. In the illustrated example, ambient levels 216 may extend across a range of environments, from very low ambient-light conditions to very high ambient-light conditions, such as “Pitch Black” conditions at one end and “Direct Sunlight” at the other end. FIG. 8 further shows a first implementation 800-A, a second implementation 800-B, and a third implementation 800-C, each of which maps ambient levels 216 into different discrete sets of profiles.

In first implementation 800-A, ambient levels 216 may be mapped into two profiles 802-1 and 802-2. In some implementations, profile 802-1 may correspond to a low-brightness mode and profile 802-2 may correspond to a high-brightness mode, such as those that have been described in certain examples above. A controller may transition between these two profiles when ambient levels 216 satisfy a criterion such as crossing a threshold between two ambient-light bands. This implementation may provide a binary mode-toggle approach with the benefit of reduced calibration complexity.

In second implementation 800-B, ambient levels 216 are shown to be mapped into three profiles 804-1, 804-2, and 804-3, whereas in third implementation 800-C, ambient levels 216 are shown to be mapped into four profiles 806-1, 806-2, 806-3, and 806-4. These examples illustrate that the display system may use more than two profiles where additional granularity is desired. For example, a larger number of profiles may allow the display system to more closely tailor current, color-space behavior, white-point maintenance behavior, global brightness behavior, and/or target contrast behavior to different ambient-light conditions, thereby reducing compromise between widely different environments. In some implementations, each profile may be associated with a different target contrast, a different current for one or more primary colors, a different global brightness behavior, and a different relationship between values representative of content and drive signals.

The illustrated implementations of FIG. 8 will be understood to be non-limiting examples. In other examples, however, profile ranges need not be equally spaced across ambient levels 216. Instead, some profiles may span a relatively larger portion of the ambient-light range while other profiles span a relatively smaller portion, such as where finer control is desired in certain brightness regions. Additionally, adjacent profiles may overlap to introduce hysteresis between transitions, such that a first threshold may be used when transitioning from a lower profile to a higher profile and a different threshold may be used when transitioning from the higher profile back to the lower profile. Such overlap and hysteresis may help reduce rapid toggling or oscillation between profiles when ambient conditions fluctuate near a transition boundary. Accordingly, FIG. 8 shows that a continuous range of ambient conditions may be quantized into discrete sets of operating profiles selected according to one or more criteria, with the number, spacing, and transition behavior of those profiles varying across implementations.

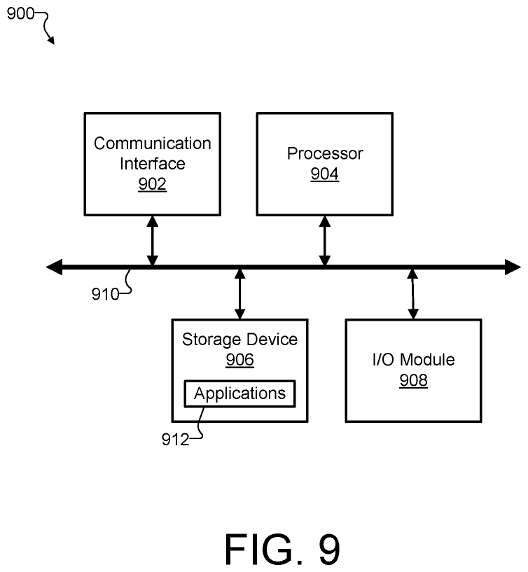

FIG. 9 illustrates an example computing system 900 that may be used in implementing one or more of the systems and methods described herein. In the illustrated example, computing system 900 includes a communication interface 902, a processor 904, a storage device 906, an input/output module 908, and a communication infrastructure 910. Storage device 906 is further shown as storing applications 912. Computing system 900 may be used in implementing, for example, all or part of a display system, a controller, a profile-selection engine, a brightness-control engine, and/or another suitable component described herein.

Communication interface 902 may be implemented by any suitable wired interface, wireless interface, network interface, transceiver, port, bus interface, and/or other communication circuitry. In some implementations, communication interface 902 may support communication with one or more external devices, sensors, displays, companion devices, head-mounted components, mobile devices, and/or other systems. Thus, communication interface 902 may allow computing system 900 to receive information used in selecting a profile and to transmit information used in controlling operation of a transparent display.

Processor 904 may be implemented by any suitable processing device or combination of processing devices, including one or more microprocessors, microcontrollers, digital signal processors, graphics processors, display processors, application-specific integrated circuits, field-programmable gate arrays, and/or other control circuitry. In some implementations, processor 904 may execute applications 912 to perform one or more operations described herein, such as receiving sensor information, determining ambient levels, selecting a profile, determining a target contrast, updating an analog current or another current-related setting, modifying a relationship between values representative of content and drive signals, determining a global brightness, and/or controlling presentation of content by a transparent display.

Storage device 906 may be implemented by any suitable non-transitory computer-readable medium or combination of such media, including volatile memory, non-volatile memory, random-access memory, read-only memory, flash memory, magnetic storage, optical storage, and/or other memory or storage arrangements. In some implementations, storage device 906 may store applications 912 together with one or more profile definitions, lookup tables, calibration data, thresholds, transition criteria, hysteresis parameters, brightness parameters, current settings, white-point settings, and/or other data used in carrying out the disclosed techniques.

Input/output module 908 may be implemented by any suitable interface or collection of interfaces for interacting with sensors, displays, user-interface devices, and/or other peripheral components. In some implementations, input/output module 908 may receive information from an ambient light sensor, an image sensor, an array of photosensors, and/or another sensing arrangement, and may provide output information to pixel-driving circuitry, display hardware, and/or another output device. Thus, input/output module 908 may support both the collection of environmental information and control of hardware used in presenting content.

Communication infrastructure 910 may be implemented by any suitable internal bus, interconnect, fabric, switching arrangement, and/or other architecture for exchanging data among components of computing system 900. For example, communication infrastructure 910 may support the exchange of data and control information among communication interface 902, processor 904, storage device 906, and input/output module 908. In this way, communication infrastructure 910 may facilitate coordinated operation of the components shown in FIG. 9.

Applications 912 may include one or more software modules, firmware modules, routines, services, control logic blocks, and/or other machine-readable instructions that, when executed by processor 904, cause computing system 900 to perform one or more of the operations described herein. In some implementations, applications 912 may implement profile selection, current selection, drive-signal generation, white-point maintenance, brightness control, hysteresis control, and/or other operations associated with adapting a transparent display to different ambient-light conditions.

Although FIG. 9 shows one example arrangement, the components shown in FIG. 9 are illustrative only. In other implementations, one or more components may be added, omitted, combined, distributed, and/or implemented in another suitable manner. For example, functions described as being performed by computing system 900 may be implemented by circuitry located within a transparent display, by circuitry located in a housing or frame associated with the transparent display, by circuitry located in a companion device carried by a user, and/or by any suitable combination thereof.

The following clauses describe implementations of current modulation based on ambient light for a transparent display in accordance with principles described herein.

Clause 1. A method comprising: detecting an ambient level of light in an environment in which a transparent display with an array of emitters is operated; determining, based on the ambient level, a profile from a plurality of profiles associated with the transparent display, the profile being associated with a current for a primary color defining a color space displayable by the transparent display; and driving, based on the profile and using drive signals defined by a relationship that is modified to maintain a white point for the color space, the array of emitters at the current.

Clause 2. The method of clause 1, wherein: the determining of the profile is based on a target contrast for the transparent display given the ambient level; and the driving of the array of emitters includes updating the current to cause the transparent display to present from the color space defined by the primary color as driven by the current, determining a global brightness that achieves the target contrast, and using pulse-width modulation to present content at the global brightness.

Clause 3. The method of clause 2, wherein the driving of the array of emitters includes updating the current by: identifying, within a pixel driver for an emitter, a first current source and a second current source; and changing which of the first current source and the second current source are enabled.

Clause 4. The method of clause 1, wherein: the determining of the profile includes selecting the profile from the plurality of profiles based on the ambient level; the relationship is a mapping between brightness values associated with content to be displayed and the drive signals used for the driving of the array of emitters; and the method further comprises modifying the relationship based on the selected profile.

Clause 5. The method of clause 4, wherein the modifying of the relationship includes: determining, based on the profile, a color shift from a reference primary color to the primary color caused by the current; and adjusting, based on the color shift, a ratio of drive signals for the primary color and at least one additional primary color defining the color space to maintain the white point at a reference white point.

Clause 6. The method of clause 5, wherein the modifying of the relationship further includes: identifying an overlapping region between a reference color space and the color space; and further adjusting the ratio of drive signals to cause colors within the overlapping region to appear equivalent across a transition from a reference profile to the profile.

Clause 7. The method of clause 1, wherein: the primary color is red; and the current shifts the red primary color toward a shorter wavelength.

Clause 8. The method of clause 7, wherein the profile defines: the current as a modulated current for the red primary color based on the ambient level; and a fixed current for at least one of a green primary color and a blue primary color of the color space.

Clause 9. The method of clause 7, wherein the profile defines: the current as a first modulated current for the red primary color based on the ambient level; and a second modulated current for at least one of a green primary color and a blue primary color defining the color space.

Clause 10. The method of clause 1, wherein: the determining of the profile includes determining a target contrast for the transparent display based on the ambient level and identifying the profile based on the target contrast; and the determining of the target contrast includes identifying, based on the ambient level, the target contrast from a discrete set of contrast ratios for different ambient levels.

Clause 11. The method of clause 1, wherein the determining of the profile is performed in response to the ambient level meeting a criterion associated with a change in the environment.

Clause 12. The method of clause 11, wherein: the plurality of profiles includes a first profile associated with a low-brightness mode and a second profile associated with a high-brightness mode; and the determining of the profile includes toggling between the first profile and the second profile in response to the criterion being met by the change in the environment.

Clause 13. The method of clause 1, wherein: the emitters of the array of emitters are micro light-emitting diodes (microLEDs); the primary color is red; and the red primary color is implemented by microLEDs constructed from an aluminum indium gallium phosphorus (AlInGaP) semiconductor material.

Clause 14. The method of clause 1, wherein: the current produces a color shift in the primary color toward a shorter wavelength; and the color shift results in a perceptual color difference of at least 20 ΔE00 for the primary color.

Clause 15. A display system comprising: a transparent display having an array of emitters; a sensor configured to detect an ambient level of light in an environment in which the transparent display is operated; and a controller communicatively coupled to the transparent display and the sensor, the controller configured to: determine, based on the ambient level, a profile from a plurality of profiles associated with the transparent display, the profile being associated with a current for a primary color defining a color space displayable by the transparent display; and drive, based on the profile and using drive signals defined by a relationship that is modified to maintain a white point for the color space, the array of emitters at the current.

Clause 16. The display system of clause 15, wherein: the controller determines the profile by selecting the profile from the plurality of profiles based on the ambient level; the relationship is a mapping between brightness values associated with content to be displayed and the drive signals used for the driving of the array of emitters; and the controller is further configured to modify the relationship based on the selected profile.

Clause 17. The display system of clause 16, wherein the transparent display is an optical see-through display, and the controller determines the profile by selecting the profile further based on a contrast ratio determined based on light from the array of emitters being additive to the ambient level.

Clause 18. The display system of clause 15, wherein: the display system is an extended reality display system, and the transparent display is a head-mounted display; and the sensor includes at least one of an ambient light sensor, an image sensor, and an array of photosensors integrated with the head-mounted display.

Clause 19. A non-transitory computer-readable medium storing instructions that, when executed by a controller of a display system having a transparent display with an array of emitters, cause the display system to perform a method comprising: detecting an ambient level of light in an environment in which the transparent display is operated; determining, based on the ambient level, a profile from a plurality of profiles associated with the transparent display, the profile being associated with a current for a primary color defining a color space displayable by the transparent display; and driving, based on the profile and using drive signals defined by a relationship that is modified to maintain a white point for the color space, the array of emitters at the current.

Clause 20. The non-transitory computer-readable medium of clause 19, wherein: the relationship is a mapping between brightness values associated with content to be displayed and the drive signals used for the driving of the array of emitters; and the method further comprises modifying the relationship based on the selected profile, the modifying including: determining, based on the profile, a color shift from a reference primary color to the primary color caused by the current; and adjusting, based on the color shift, a ratio of drive signals for the primary color and at least one additional primary color defining the color space to maintain the white point at a reference white point.

Various implementations of the systems and techniques described herein can be realized in digital electronic circuitry, integrated circuitry, specially designed ASICs (application-specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A number of implementations have been described. It will be understood that various modifications may be made without departing from the spirit and scope of the description and claims. The described implementations are examples, and other systems can be used to perform similar functions. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the implementations of the disclosure.

The terminology used herein is for the purpose of describing particular implementations only and is not intended to be limiting of the implementations. As used herein, the singular forms “a,” “an,” and “the” are intended to include the plural forms as well, unless the context clearly indicates otherwise. It will be further understood that the term “comprising,” when used in this specification, specifies the presence of the stated features, steps, operations, elements, and/or components, but does not preclude the presence or addition of one or more other features, steps, operations, elements, components, and/or groups thereof.

It will be understood that when an element is referred to as being “coupled” or “connected” to another element, it can be directly coupled or connected to the other element, or intervening elements may also be present. In contrast, when an element is referred to as being “directly coupled” or “directly connected” to another element, there are no intervening elements present.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (e.g., rotated 90 degrees or at other orientations) and the spatially relative descriptors used herein may be interpreted accordingly.

Further to the descriptions above, a user may be provided with controls allowing the user to make an election as to both if and when systems, programs, or features described herein may enable collection of user information (e.g., information about a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized, such as to a city, zip code, or state level, so that a particular location of a user cannot be determined. Thus, the user may have control over what information is collected about the user, how that information is used, and what information is provided to the user.

While certain features of the described implementations have been illustrated as described herein, many modifications, substitutions, changes, and equivalents may occur to those skilled in the art. It is therefore to be understood that the appended claims are intended to cover such modifications and changes as fall within the scope of the implementations. It will be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described. As such, the scope of the present disclosure is not limited to the particular combinations hereafter claimed, but instead extends to encompass any combination of features or example implementations described herein irrespective of whether or not that particular combination has been specifically enumerated in the accompanying claims at this time.

What is claimed is:

1. A method comprising:
detecting an ambient level of light in an environment in which a transparent display with an array of emitters is operated;
determining, based on the ambient level, a profile from a plurality of profiles associated with the transparent display, the profile being associated with a current for a primary color defining a color space displayable by the transparent display; and
driving, based on the profile and using drive signals defined by a relationship that is modified to maintain a white point for the color space, the array of emitters at the current.

2. The method of claim 1, wherein:
the determining of the profile is based on a target contrast for the transparent display given the ambient level; and
the driving of the array of emitters includes updating the current to cause the transparent display to present from the color space defined by the primary color as driven by the current, determining a global brightness that achieves the target contrast, and using pulse-width modulation to present content at the global brightness.

3. The method of claim 2, wherein the driving of the array of emitters includes updating the current by:
identifying, within a pixel driver for an emitter, a first current source and a second current source; and
changing which of the first current source and the second current source are enabled.

4. The method of claim 1, wherein:
the determining of the profile includes selecting the profile from the plurality of profiles based on the ambient level;
the relationship is a mapping between brightness values associated with content to be displayed and the drive signals used for the driving of the array of emitters; and
the method further comprises modifying the relationship based on the selected profile.

5. The method of claim 4, wherein the modifying of the relationship includes:
determining, based on the profile, a color shift from a reference primary color to the primary color caused by the current; and
adjusting, based on the color shift, a ratio of drive signals for the primary color and at least one additional primary color defining the color space to maintain the white point at a reference white point.

6. The method of claim 5, wherein the modifying of the relationship further includes:
identifying an overlapping region between a reference color space and the color space; and
further adjusting the ratio of drive signals to cause colors within the overlapping region to appear equivalent across a transition from a reference profile to the profile.

7. The method of claim 1, wherein:
the primary color is red; and
the current shifts the red primary color toward a shorter wavelength.

8. The method of claim 7, wherein the profile defines:
the current as a modulated current for the red primary color based on the ambient level; and
a fixed current for at least one of a green primary color and a blue primary color of the color space.

9. The method of claim 7, wherein the profile defines:
the current as a first modulated current for the red primary color based on the ambient level; and
a second modulated current for at least one of a green primary color and a blue primary color defining the color space.

10. The method of claim 1, wherein:
the determining of the profile includes determining a target contrast for the transparent display based on the ambient level and identifying the profile based on the target contrast; and
the determining of the target contrast includes identifying, based on the ambient level, the target contrast from a discrete set of contrast ratios for different ambient levels.

11. The method of claim 1, wherein the determining of the profile is performed in response to the ambient level meeting a criterion associated with a change in the environment.

12. The method of claim 11, wherein:
the plurality of profiles includes a first profile associated with a low-brightness mode and a second profile associated with a high-brightness mode; and
the determining of the profile includes toggling between the first profile and the second profile in response to the criterion being met by the change in the environment.

13. The method of claim 1, wherein:
the emitters of the array of emitters are micro light-emitting diodes (microLEDs);
the primary color is red; and
the red primary color is implemented by microLEDs constructed from an aluminum indium gallium phosphorus (AlInGaP) semiconductor material.

14. The method of claim 1, wherein:
the current produces a color shift in the primary color toward a shorter wavelength; and
the color shift results in a perceptual color difference of at least 20 ΔE₀₀ for the primary color.

15. A display system comprising:
a transparent display having an array of emitters;
a sensor configured to detect an ambient level of light in an environment in which the transparent display is operated; and
a controller communicatively coupled to the transparent display and the sensor, the controller configured to:
determine, based on the ambient level, a profile from a plurality of profiles associated with the transparent display, the profile being associated with a current for a primary color defining a color space displayable by the transparent display; and
drive, based on the profile and using drive signals defined by a relationship that is modified to maintain a white point for the color space, the array of emitters at the current.

16. The display system of claim 15, wherein:
the controller determines the profile by selecting the profile from the plurality of profiles based on the ambient level;
the relationship is a mapping between brightness values associated with content to be displayed and the drive signals used for the driving of the array of emitters; and
the controller is further configured to modify the relationship based on the selected profile.

17. The display system of claim 16, wherein the transparent display is an optical see-through display, and the controller determines the profile by selecting the profile further based on a contrast ratio determined based on light from the array of emitters being additive to the ambient level.

18. The display system of claim 15, wherein:
the display system is an extended reality display system, and the transparent display is a head-mounted display; and
the sensor includes at least one of an ambient light sensor, an image sensor, and an array of photosensors integrated with the head-mounted display.

19. A non-transitory computer-readable medium storing instructions that, when executed by a controller of a display system having a transparent display with an array of emitters, cause the display system to perform a method comprising:
detecting an ambient level of light in an environment in which the transparent display is operated;
determining, based on the ambient level, a profile from a plurality of profiles associated with the transparent display, the profile being associated with a current for a primary color defining a color space displayable by the transparent display; and
driving, based on the profile and using drive signals defined by a relationship that is modified to maintain a white point for the color space, the array of emitters at the current.

20. The non-transitory computer-readable medium of claim 19, wherein:
the relationship is a mapping between brightness values associated with content to be displayed and the drive signals used for the driving of the array of emitters; and
the method further comprises modifying the relationship based on the selected profile, the modifying including:
determining, based on the profile, a color shift from a reference primary color to the primary color caused by the current; and
adjusting, based on the color shift, a ratio of drive signals for the primary color and at least one additional primary color defining the color space to maintain the white point at a reference white point.
